(19) United States
(12) Patent Application Publication
(10) Pub. No.: US 2005/0212950 A1
(43) Pub. Date: Sep. 29, 2005

(54) Focal length detecting method, focusing device, image capturing method and image capturing apparatus

(75) Inventor: Kunihiko Kanai, Suwa-shi (JP)

Correspondence Address: Barry E. Bretschneider;Morrison & Foerster LLP, Suite 300, 1650 Tysons Boulevard, McLean, VA, 22102, US

(73) Assignee: Chinon Kabushiki Kaisha, Chino-shi (JP)

(21) Appl. No.: 10/809,812

(22) Filed: Mar. 26, 2004

(51) Int. Cl. H04N 5/228

(52) U.S. Cl. 348/345

(57) ABSTRACT

An image processing circuit enables the accurate detection of the focal length for focusing by using color data. The image processing circuit generates image data representing brightness and each of the colors of red, green and blue, image data to be used for focusing is selected either automatically or manually from the image data representing the brightness and the respective colors, and the amount of the weight for each respective image data is set. Images are photographed while the optical system is driven to change its focal length. A focal length is calculated for each selected image data. Weight is applied to each one of the calculated focal lengths so as to calculate a final focal length. This not only ensures accurate measurement of the distance for focusing but also increases the possibility of focusing on a subject which is characterized by specific color data.

### TECHNICAL FIELD

The present invention relates to a focal length detecting method, a focusing device, an image capturing method and an image capturing apparatus for detecting a focal length based on image data.

### BACKGROUND OF THE INVENTION

In some conventional image capturing apparatuses, such as video cameras and electronic still cameras, focusing a lens calls for extracting a high-frequency component from data of a captured image. To be more specific, the focusing process comprises steps of capturing an image while driving the lens to move its focal point and extract high-frequency components respectively at various positions of the lens, calculating evaluated value of contrast (such a value is hereinafter referred to as contrast) based on the extracted high-frequency components, and moving the lens in such a direction as to increase the contrast. The position where the contrast is at the maximum is regarded as the focusing position of the lens.

A conventionally known example of such constitution is described in Japanese Laid-open Patent Publication No. 02-214272, which offers a device that uses a high frequency component in a brightness signal. The aforementioned device has a constitution such that when a targeted subject is a person, the device aims at reliable focusing on the subject by using a color differential signal to detect a skin color part from image data and increasing the weighting of the high frequency component in the brightness signal for the skin color part.

As shown in Japanese Laid-open Patent Publication No. 04-150692, another example of conventional art is provided with a circuit for detecting a skin color part from image signals and is adapted to function such that when a subject contains a skin color, on which the lens is focused, exposure is controlled so that the appropriate exposure is achieved for the skin color part. The device has such a constitution as to detect a correctly focused state based on whether the high frequency component in a brightness signal has reached a given level.

As shown in Japanese Laid-open Patent Publication No. 05-53041, yet another example of conventional art calls for detecting a skin color part from image signals to judge whether the principal subject is a person, and, when the principal subject has been ascertained to be a person, setting the lens driving speed for automatic focusing at a low speed in order to stop the lens with high precision.

Conventionally known methods of photography include what is commonly called bracket photography, which is a photographing method for successively capturing multiple image data with a single photographing action so as to ensure that the photographer captures the subject that he intends. There are various examples of conventional bracket photography, including one that uses a plurality of white balances when performing photographing, focus bracket photography for capturing images at a plurality of focal lengths, and exposure bracket photography for changing exposure towards the plus side and the minus side, with the exposure that is judged to be appropriate in the middle.

An example of bracket photography based on white balance is described in Japanese Patent Publication No. 3332396, which offers a constitution that calls for dividing a photography screen into a plurality of division fields and capturing images with white balances respectively set for these division fields.

An example of focus bracket photography is described in Japanese Laid-open Patent Publication No. 2001-116979, which offers a constitution that calls for measuring the distance to each one of a plurality of subjects present in a photographic range and performing photographing at each focus position. According to this constitution, the distances to a plurality of subjects are measured by detecting peak positions of evaluated values of high frequency components while moving the lens or measuring a subject distance in each range finding area.

### SUMMARY OF THE INVENTION

As described above, a constitution that takes not of a skin color part is effective only for photographing of a human subject. Furthermore, human skin usually presents low contrast, which often causes erroneous detection of a focal length, particularly when there is some other object having a color similar to the human skin color. In other words, a constitution described in any one of the relevant patent documents mentioned above relates to focusing based on a single kind of information, i.e. either brightness data or information similar to brightness data, and enables accurate focusing only under specific conditions.

Focus bracket photography increases the possibility of correct focusing on a targeted subject. However, should the brightness data of a targeted subject have low contrast, there is the possibility of a failure to focus on the targeted subject, because the contrast in the brightness data may not be detected as a peak of the evaluated values of the high frequency components or as a subject in a range finding area.

In order to solve the above problems, an object of the present invention is to provide a focal length detecting method and a focusing device which are capable of accurate detection of a focal length in response to various types of subjects or photographing conditions. Another object of the present invention is to provide an image capturing method and an image capturing apparatus which present a greater possibility of capturing an image for which the lens is correctly focused for a subject on which the photographer intends to focus.

A method of detecting a focal length according to the present invention calls for obtaining, while changing the focal length of an optical system, multiple image data selected from among image data consisting of brightness data and a plurality of color data, and calculating a focal length from the obtained multiple image data by using the peak value of contrast evaluated values of said multiple image data.

As the focal length is calculated based on the image data that is selected from brightness data and a plurality of color data and contains the information appropriate for contrast detection, the focal length to a subject containing various color data can be correctly detected in various photographing conditions.

According to the invention, weighting of the evaluated values of each image data of each respective color data that has been selected is automatically performed based on conditions set for said each image data.

By automatic weighting of the evaluated values, correct detection of the focal length can be easily performed.

According to the invention, the operator performs by the operator's discretion weighting of the evaluated values of each image data of each respective color data that has been selected.

With the feature described above, the focal length to a subject that is of a specific color or has other similar conditions can be accurately and easily detected in accordance with the operator's intention.

According to the invention, a photographing mode for calculating a focal length by using only image data that consists of color data of a specific color selected based on a subject is provided.

Therefore, using only the image data that consists of the color data of a specific color ensures easy focusing for a subject on which the operator intends to focus on without being affected by other color data.

According to the invention, auxiliary light with given color data is emitted when the image data is obtained, and weighting of the evaluated values of the color image data is performed based on the color data of the emitted auxiliary light.

With the feature described above, by emitting auxiliary light that is appropriate to detect contrast and performing weighting of the evaluated values of the color image data based on the color data of the emitted auxiliary light, accurate detection of the focal length is ensured while making effective use of the auxiliary light.

According to the invention, the method calls for setting a plurality of image detecting areas adjacent to one another in each one of the obtained multiple image data, calculating a partial focal length for each image detecting area based on which image data the peak value of contrast evaluated values has been recorded in, calculating the reliability of each image detecting area based on the position at which said peak value has been recorded moving across the multiple image data, and selecting a focal length from a group consisting of said partial focal lengths and at least one given focal length, said focal length selected based on the reliability and the evaluated values of each respective image detecting area.

As each reliability is calculated based on the position at which the peak value of the contrast evaluated values has been recorded moving across the multiple image data so that the partial focal length of an image detecting area that has a low reliability due to relative movement of the subject is excluded from selection, the method described above enables the accurate detection of the focal length.

A focusing device according to the invention includes an image pickup device, an optical system for forming an image on the image pickup device, an optical system driving means for changing the focal length of the optical system, and an image processing means for processing image data output from the image pickup device and controlling the optical system driving means, wherein the image processing means is adapted to obtain, while changing the focal length of the optical system, multiple image data selected from among image data of brightness data and a plurality of color data, and calculate a focal length from the obtained multiple image data by using the peak value of contrast evaluated values of said multiple image data.

As the focal length is calculated based on the image data that is selected from brightness data and a plurality of color data and contains the information appropriate for contrast detection, accurate focusing for a subject containing various color data can be ensured in various photographing conditions.

According to the invention, the focusing device is provided with an operating means which enables the operator to perform by the operator's discretion weighting of the evaluated values of each image data of each respective color data that has been selected.

With the feature described above, accurate focusing for a subject that is of a specific color or has other similar conditions can be ensured in accordance with the operator's intention.

According to the invention, the image processing means is adapted to automatically perform weighting of the evaluated values of each image data of each respective color data that has been selected based on conditions set for said each image data.

By automatic weighting of the evaluated values, accurate focusing is ensured.

According to the invention, the focusing device is provided with an auxiliary light device for emitting light with given color data.

The device having this constitution enables the accurate focusing by effectively using auxiliary light.

According to the invention, the image processing means is adapted to set a plurality of image detecting areas adjacent to one another in each one of the obtained multiple image data, calculate a partial focal length for each image detecting area based on which image data the peak value of contrast evaluated values has been recorded in, calculate the reliability of each image detecting area based on the position at which said peak value has been recorded moving across the multiple image data, and select a focal length from a group consisting of said partial focal lengths and at least one given focal length, said focal length selected based on the reliability and the evaluated values of each respective image detecting area.

As each reliability is calculated based on the position at which the peak value of the contrast evaluated values has been recorded moving across the multiple image data so that the partial focal length of an image detecting area that has a low reliability due to relative movement of the subject is excluded from selection, the method described above enables the accurate focusing.

An image capturing method according to the invention calls for using color data of a plurality of colors to detect a focal length for each respective color data and capturing an image at each focal length detected for each respective color data.

With the feature described above, capturing images at focal lengths that have been respectively detected by using color data of a plurality of colors increases the possibility of focusing on a subject which is characterized by specific color data. Therefore, the possibility of capturing an image for which the lens is correctly focused for a subject on which the photographer intends to focus is increased.

According to the invention, a plurality of photographing modes can be selected, and, should a plurality of photographing modes be simultaneously selected, focal lengths are detected for each one of the selected photographing modes by using color data of a plurality of colors, and images are captured at the respected focal lengths that have been detected.

With the feature described above, capturing images at focal lengths that have been respectively detected by using color data of a plurality of colors for each one of the selected photographing modes increases the possibility of focusing on a subject which is characterized by specific color data. Therefore, the possibility of capturing an image for which the lens is correctly focused for a subject on which the photographer intends to focus is increased.

According to the invention, focal length detection calls for obtaining a plurality of image data of each respective color data while changing the focal length of an optical system, setting a plurality of image detecting areas adjacent to one another for the image data of each color data, calculating a partial focal length for each image detecting area based on which image data the peak value of contrast evaluated values has been recorded in, calculating the reliability of each image detecting area based on the position at which said peak value has been recorded moving across the multiple image data, and selecting a focal length from a group consisting of said partial focal lengths and at least one given focal length, said focal length selected based on the reliability and the evaluated values of each respective image detecting area.

As each reliability is calculated based on the position at which the peak value of the contrast evaluated values has been recorded moving across the multiple image data so that the partial focal length of an image detecting area that has a low reliability due to relative movement of the subject is excluded from selection, the method described above enables the accurate detection of the focal length for each respective color data.

An image capturing apparatus according to the invention includes an image pickup device, an optical system for forming an image on the image pickup device, an optical system driving means for changing the focal length of the optical system, and an image processing means for processing image data output from the image pickup device and controlling the optical system driving means, wherein the image processing means is adapted to obtain a plurality of image data of each respective color data while changing the focal length of the optical system, calculate a focal length for each respective color data mentioned above by using the peak value of contrast evaluated values calculated from the obtained multiple image data, and perform image capturing at each focal length calculated for each respective color data.

With the feature described above, capturing images at focal lengths that have been respectively detected by using color data of a plurality of colors increases the possibility of focusing on a subject which is characterized by specific color data. Therefore, the possibility of capturing an image for which the lens is correctly focused for a subject on which the photographer intends to focus is increased.

According to the invention, the apparatus is provided with a warning means for indicating that image capturing is underway.

An image capturing apparatus having the feature described above is capable of warn the photographer not to move the image capturing apparatus away from the subject when capturing a plurality of images in sequence.

By calculating the focal length using the selected image data that contains the information appropriate for contrast detection, the present invention enables the accurate detection of a focal length in response to various types of subjects or photographing conditions. Furthermore, capturing images at focal lengths that have been respectively detected by using color data of a plurality of colors increases the possibility of focusing on a subject which is characterized by specific color data. Therefore, the possibility of capturing an image for which the lens is correctly focused for a subject on which the photographer intends to focus is increased. Therefore, the possibility of capturing an image for which the lens is correctly focused for a subject on which the photographer intends to focus is increased.

### BRIEF DESCRIPTION OF THE DRAWINGS

FIG. 1 is a block diagram of a focusing device according to an embodiment of the present invention.

FIG. 2 is a schematic illustration to explain in detail an image processing circuit of said focusing device.

FIG. 3 is a schematic illustration to explain the function of said focusing device in the state that there is no blur, wherein (a) is a schematic illustration of the relationship between windows and a subject, and (b) is a schematic illustration of a change in contrast evaluated values.

FIG. 4 is a schematic illustration of the relationship between the windows of said focusing device and the subject in a situation where there is blur.

FIG. 5 is a schematic illustration to explain the function of said focusing device in a situation where there is blur, wherein (a) is a schematic illustration of the relationship between the windows and the subject, and (b) is a schematic illustration of a change in evaluated values of contrast of the windows W4,W5.

FIG. 6 is a schematic illustration of the relationship between the windows of said focusing device and the subject in a situation where there is blur.

FIG. 7 is a flow chart showing the function of said focusing device.

FIG. 8 is a flow chart showing how said focusing device calculates the number of data images to be obtained.

FIG. 9 is a flow chart showing how said focusing device performs weighting.

FIG. 10 is a flow chart showing how said focusing device calculates a focusing distance.

FIG. 11 is a flow chart showing the function of a focusing device according to the present invention.

FIG. 12 is a flow chart showing the function of said focusing device.

FIG. 13 is a flow chart showing the function of said focusing device.

FIG. 14 is a flow chart showing the function of said focusing device.

FIG. 15 is a flow chart showing the function of said focusing device.

FIG. 16 is a flow chart showing how said focusing device calculates a focusing distance.

FIG. 17 is a flow chart showing the function of an image capturing apparatus according to another embodiment of the present invention.

FIG. 18 is a flow chart showing the function of said image capturing apparatus.

FIG. 19 is a flow chart showing the function of said image capturing apparatus.

### DETAILED DESCRIPTION OF THE INVENTION

A focal length detecting method, a focusing device, an image capturing method and an image capturing apparatus according to the present invention are explained hereunder, referring to relevant drawings.

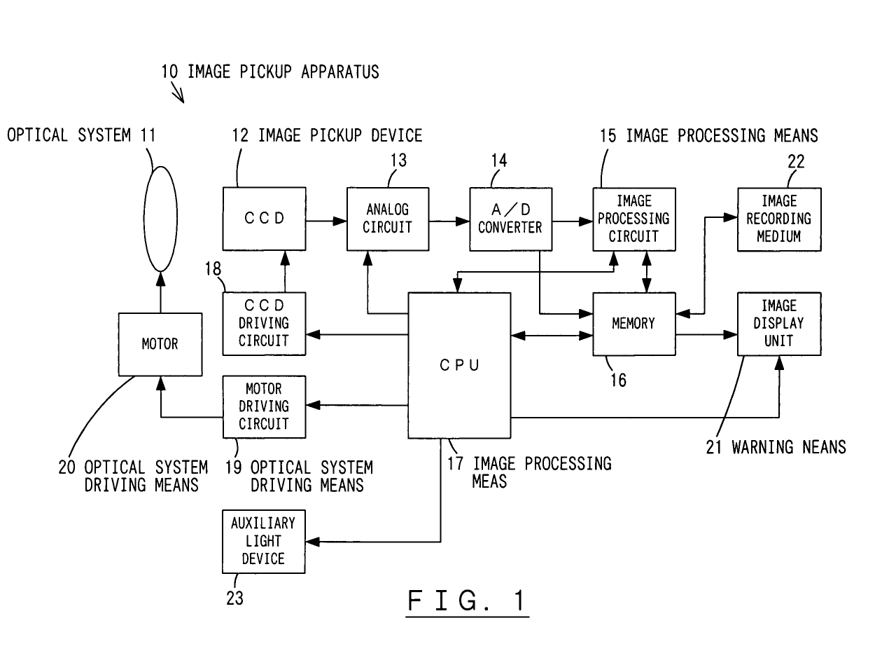

Referring to FIG. 1, numeral 10 denotes an image capturing apparatus, which is a digital camera for capturing still images and moving images and provided with a focusing device. The image capturing apparatus 10 is provided with an optical system 11 comprised of lenses, an aperture, etc., a CCD 12 as an image pickup device, an analog circuit 13 into which signals output from the CCD 12 shall be sequentially input, an A/D converter 14, an image processing circuit 15 serving as both an information selecting means and an image processing means, a memory 16 which is a RAM or the like and serves as a recording means, a CPU 17 having a function of a control means that serves as an image processing means, a CCD driving circuit 18 adapted to be controlled by the CPU 17 so as to drive the CCD 12, a motor driving circuit 19 serving as an optical system driving means that is adapted to be controlled by the CPU 17, a motor 20 serving as an optical system driving means, a liquid crystal display or the like serving as an image display unit 21 which also functions as a warning means, a memory card or the like serving as an image recording medium 22, an auxiliary light device 23 serving as an information selecting means, and other components that are not shown in the drawings, including a housing, a power supply unit, input and output terminals, and operating means such as a shutter button, switches, a photographing mode selecting means, etc. The aforementioned motor 20 is adapted to be driven by the motor driving circuit 19 so as to change the focal length by moving back and forth a lens of the optical system 11, e.g. a focus lens.

The CCD 12 is a CCD-type solid-state image pickup device, which is an image sensor using a charge-coupled device. The CPU 17 is what is commonly called a microprocessor and controls the entire system. According to the present embodiment, the CPU 17 controls the aperture and focus, i.e. focal length, of the optical system 11. The CPU 17 performs the focus control by causing through the motor driving circuit 19 the motor 20 to drive the optical system 11 so as to move a single or a plurality of focus lenses back and forth. Other functions of the CPU 17 include control of driving of the CCD 12, which is performed through control of the CCD driving circuit 18, control of such circuits as the analog circuit 13 and the image processing circuit 15, processing data to be recorded to the memory 16, control of the image display unit 21, recording/reading of image data to or from the image recording medium 22, and emitting auxiliary light by means of the auxiliary light device 23. The memory 16 consists of an inexpensive DRAM or the like and is used by a plurality of components; it is where the CPU 17 runs programs, the CPU 17 and the image processing circuit 15 perform their respective work, input/output to and from the image recording medium 22 is buffered, and it is where other image data is temporarily stored.

The CPU 17 controls the aperture and other relevant parts of the optical system 11 to adjust the intensity of the light off subject that strikes the CCD 12. The CCD 12 is driven by the CCD driving circuit 18 so that an analog image signal resulting from photo-electric conversion of the light off subject is output from the CCD 12 to the analog circuit 13. The CPU 17 also serves to control an electronic shutter of the CCD 12 through the CCD driving circuit 18. The analog circuit 13 consists of a correlated double sampling means and a gain control amplifier and functions to remove noises or amplify analog image signals output from the CCD 12. The CPU 17 controls the degree of amplification by the gain control amplifier of the analog circuit 13 or other functions of the analog circuit 13.

The output signals from the analog circuit 13 are input into the A/D converter 14, by which they are converted into digital signals. The image signals thus converted into digital signals are either input into the image processing circuit 15 or temporarily stored directly in the memory 16 for later processing. Image signals that have been input in the image processing circuit 15 undergo image processing and then output into the memory 16, and they are subsequently either displayed on the image display unit 21 or, depending on operation by the user, recorded in the image recording medium 22 as a moving image or a still image. The unprocessed image data that has temporarily been stored in the memory 16 is processed by either one of or both the CPU 17 and image processing circuit 15.

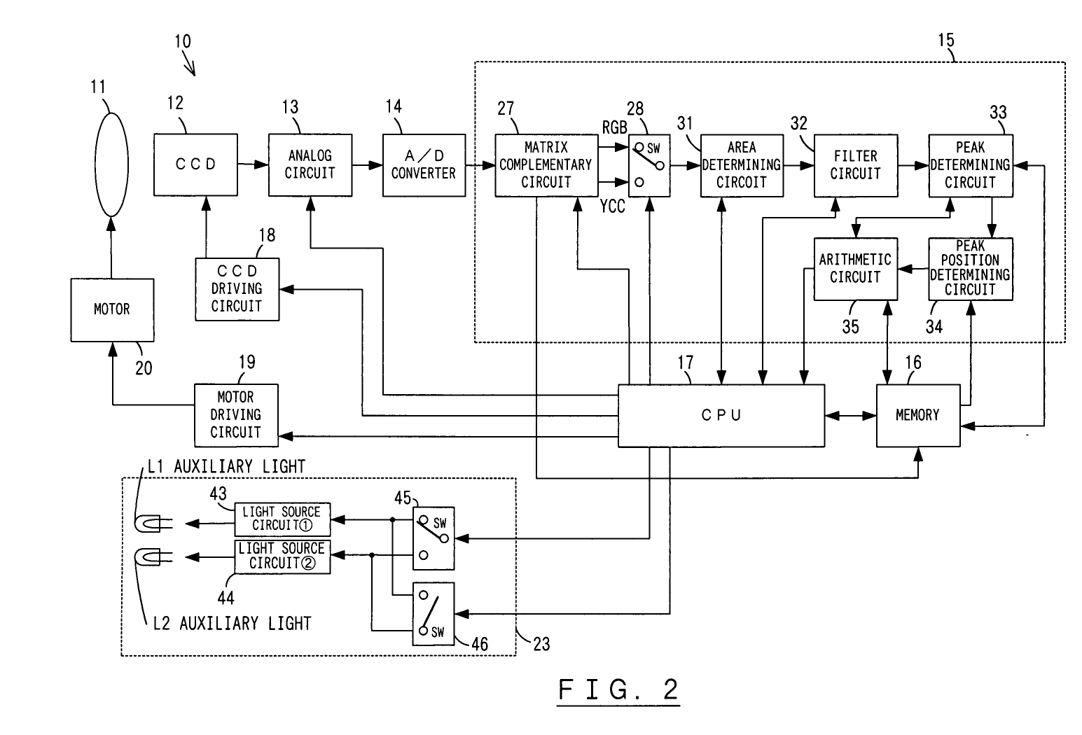

As shown in FIG. 2, the image processing circuit 15 according to the present embodiment includes a matrix complementary circuit 27, a switch 28, an area determining circuit 31, filter circuits 32 serving as a contrast detecting means, a peak determining circuit 33, a peak position determining circuit 34, and an arithmetic circuit 35.

At a given lens position, in other words in the state where the optical system 11 is set at an appropriate focal length, an image of a subject entering the optical system 11 is converted into analog image signals through the CCD 12 and then into digital image data through the analog circuit 13 and the A/D converter 14. The digital image data output from the A/D converter 14 is stored in the memory 16. At the same time, the image processing circuit 15 process the digital image data in order to control focusing, exposure and other necessary operations. To be more specific, the image data converted into digital image data by the A/D converter 14 is input into the matrix complementary circuit 27, which performs color conversion or complementary processing of the data and outputs image data for focus control or exposure control as YCC brightness data (hereinafter referred to as brightness data) and RGB signal data (hereinafter referred to as color data). Various settings for these conversions may be changed by the CPU 17 in accordance with a program. The aforementioned brightness data and color data output from the matrix complementary circuit 27 are input into the switch 28, which is adapted to be controlled by the CPU 17. The brightness data and the color data input into the switch 28 are selected as image data for control based on various photographing conditions or other criteria and output from the switch 28. The image processing circuit 15 is thus able to output image data as RGB image data consisting of red signals (R), green signals (G) and blue signals (B), in addition to image data representing normal YCC brightness data.

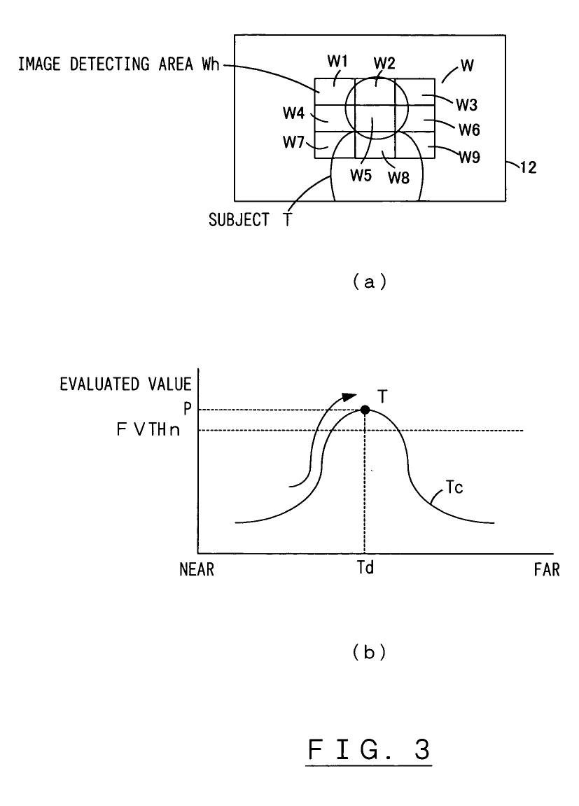

The image data output from the switch 28 is input into the area determining circuit 31, which applies the image data area determining processing in order to determine an image focusing area W shown in FIG. 3 and other drawings. The image focusing area W is an image area used for focusing and has a plurality of image detecting areas Wh. In the case of the present embodiment, the image detecting areas Wh consist of windows W1-W9. The explanation hereunder is given based on the assumption that there is provided a means to calculate a distance from the optical system 11 to a subject T (such a distance is hereinafter referred to as the subject distance) in the windows W1-W9, in other words in the range that covers plural parts of the subject T. To be more specific, in order to determine whether the contrast is high or low in each window W1-W9 of the image focusing area W, the filter circuits 32 analyze high frequency components to calculate the contrast evaluated value for each window W1-W9. High-pass filters (HPF), which have a relatively high contrast, may desirably be used for the filter circuits 32.

According to the present embodiment, an image on each window W1-W9 is processed. To be more specific, the peak determining circuit 33 determines the highest value of the evaluated values that have been calculated by the filter circuits 32, each of which is adapted to process each respective horizontal line of each window W1-W9. The peak determining circuit 33 outputs said highest value as the evaluated value for each respective window W1-W9. The position of a highest value on image data, which value has been determined by the peak determining circuit 33, is called a peak position. Each peak position is calculated by the peak position determining circuit 34 from the starting point of each respective window W1-W9 currently undergoing calculation. Outputs from the peak determining circuit 33 and the peak position determining circuit 34, in other words the peak values of the contrast evaluated values of the respective horizontal lines in the windows W1-W9 and the peak positions at which the peak values have been recorded, are temporarily stored in the memory 16.

The peak values and peak positions calculated for the horizontal lines of the CCD 12 are summed up by the arithmetic circuit 35 in each window W1-W9 so that the summed peak value and the summed peak position of each window W1-W9 are output as the value of each window W1-W9 from the arithmetic circuit 35 to the CPU 17. The aforementioned “summed peak position” means the average position with respect to the horizontal direction. The arithmetic circuit 35 is an adder which serves as a calculating means. For calculation of summed peak values of the respective windows W1-W9, the arithmetic circuit 35 may be adapted to carry out calculation only for peak values higher than a given level.

The optical system 11 is driven to change the lens position within a set range, i.e. the driving range, so that summed peak values and summed peak positions are calculated at each lens position and stored in the memory 16. The aforementioned driving range, in other words the number of images to be captured for focusing, may be set appropriately based on the magnification of the lens, the photographing distance, various photographing conditions set by the photographer, etc. In case of a short subject distance, such as when a calculated evaluated value is higher than a given value, i.e. FVTHn shown in FIG. 3(b), the driving range may be reduced to shorten the duration of focusing.

The peak values of each window W1-W9 are compared within the driving range. When there is a peak in the peak values with respect to the driving direction of the lens, it is regarded as the peak of the corresponding window W1-W9.

As it can be surmised that focusing on the subject T can be accomplished in the vicinity of said peak, a focal length surmised from the value of the peak is regarded as the partial focal length of each respective window W1-W9.

The plural windows W1-W9 constitute the image focusing area W. Therefore, if there is a window where the subject T is moving near the peak, there should be others where the subject T is captured with great certainty near the peaks of the windows without blur.

In other words, the partial focal lengths of the windows W1-W9 consist of those with a high reliability, i.e. valid values, and those with a low reliability, i.e. invalid values. Therefore, using results of calculation of the peak values and peak positions, the CPU 17 evaluates the reliability of each window W1-W9, in other words, it applies weighting to the focusing position determining means.

For example, should the average of the peak positions of a window W1-W9 be rapidly moving near the partial focal length of the window, or the average of the peak positions of a window W1-W9 that is horizontally adjacent thereto be rapidly moving, it can be surmised that blur is occurring due to movement of the subject T. In such a case, the weight on the first-mentioned window W1-W9 is reduced. When there is no significant change in the average of the peak positions, the weight is not reduced, because it is judged that the subject T is not moving.

Should the peak position of a subject T in a window move into another window, the peak values and peak positions of the first-mentioned window change significantly. Therefore, the reliability of a window where the peak value and peak position have changed significantly is reduced by reducing the weight on such a window so that the partial focal lengths in which the subject T are captured are given priorities.

This embodiment calls for evaluating contrast peaks in the windows W1-W9 with respect to the horizontal direction. Therefore, as long as there is a contrast peak of the subject T in a window W1-W9, the evaluated value for the window does not change regardless of movement of the subject T.

A fluctuation of peak positions of peak values occurring whenever the lens is moved usually means noises or the like, in other words the absence of contrast in the pertinent window. If such is the case, it is determined that the subject T is not present in the window, and the weight on the window is reduced.

The amount of the weight may be set beforehand or calculated from evaluated values of image data or other similar factors based on various photographing conditions, such as brightness data, lens magnification, etc.

The CPU 17 multiplies an evaluated value by a weight factor, thereby obtaining a weighted evaluated value of each respective window W1-W2.

Should the weighted evaluated value be less than a given value, the CPU 17, which serves as a determining means, regards the evaluated value to be invalid and does not use it thereafter.

By summing up weighted evaluated values at each lens driven position, the CPU 17 serving as a selecting means calculates a final focusing position, where the contrast is at the maximum. To be more specific, when a calculated result of the evaluated values is input into the CPU 17, the CPU 17 performs calculation by summing up the evaluated values, i.e. the summed peak values and the summed peak positions of the windows W1-W9 with the position of the subject at the current lens position used as an evaluated value. At that time, the center of gravity of the peak positions can be found when the peak position is a value obtained by dividing the sum of the evaluated values by the number of vertical lines in each window W1-W9. After reducing the weight on the evaluated value for each window in which there is a great change in the center of gravity or a horizontal window from which the center of gravity has moved to a corner of the window, the evaluated values for the windows are summed up to produce a final evaluated value.

The CPU 17 selects as the focusing distance the shortest partial subject distance selected from among the evaluated values that have been judged to be valid. To be more specific, based on the amount of the aforementioned final evaluated value, the CPU 17 commands movement of the lens of the optical system 11 to the position having the highest final evaluated value by means of the motor driving circuit 19 and the motor 20. Should there be no change in the final evaluated value, the CPU 17 outputs a command to stop the motor 20 through the motor driving circuit 19.

As weighting prevents error in selecting the peak due to blur of the subject T, the subject T can be correctly captured by means of calculation of plural focal lengths using a plurality of areas without the problem of erroneously picking up blur. Therefore, the method described above enables reliable selection of correct focusing position by using automatic focusing that gives priority to a short range, which is generally deemed effective.

The in-focus position of the lens constituting the optical system, i.e. the position at which the lens is focused at a given distance, changes with respect to the range of photographing distance for which the lens is designed, depending on fluctuation resulting from the lens magnification, a change resulting from a change in aperture, as well as temperature, position and other conditions of the lens barrel supporting the lens. Therefore, taking into consideration the degree of change resulting from changes in these various conditions in addition to the driving range calculated from the range within which the lens is designed to be focused, the optical system 11 is provided with overstroke ranges at the short-range end and the long-range end respectively. An overstroke range is a range in which the lens is permitted to move by the distance corresponding to the degree of change. Furthermore, the control means, which is comprised of the CPU 17 or the like, is adapted to be capable of moving the lens into an overstroke area.

For example, given that the total moving distance of the in-focus position of the lens is 10 mm and that the maximum integrated value of the degree of change is 1 mm when the aforementioned designed range of photographing distance is 50 cm to infinity, a 1 mm overstroke range is provided at each end, i.e. the short-range side and the long-range end so that the lens driving range, i.e. the total moving distance of the in-focus position of the lens, is set at 12 mm (10 mm+1 mm+1 mm). By thus providing overstroke ranges and permitting to drive the lens to the overstroke ranges, the designed range of photographing distance is ensured.

In order to support focusing processing, the auxiliary light device 23 is provided with a plurality of auxiliary light sources adapted to emit light based on the brightness of a subject in low-light conditions, in other words when the subject is dark. In the case of the present embodiment, the auxiliary light sources consist of two light sources of different colors, i.e. auxiliary light sources L1,L2. The auxiliary light sources L1,L2 are respectively connected to light source circuits 43,44, which are connected to the CPU 17 through a first switch 45 and a second switch 46. The auxiliary light sources L1,L2 are adapted to be controlled by the light source circuits 43,44 to emit light respectively. The functions of the CPU 17 include giving direction as to whether each auxiliary light source L1,L2 should emit light as well as controlling lighting timing. The CPU 17 controls the first switch 45 so as to switch control of the auxiliary light source between the two auxiliary light sources L1,L2. The CPU 17 also controls the second switch 46 which determines whether or not to control the two auxiliary light sources L1,L2 simultaneously.

The number of the auxiliary light sources L1,L2 are not limited to two; three or more auxiliary light sources, i.e. an N number of auxiliary light sources L1,L2 . . . LN, may be used. The plurality of auxiliary light sources L1,L2 . . . LN may emit light beams of different colors or the same color. Furthermore, the auxiliary light sources L1,L2 . . . LN may be controlled independently, or, in an alternative structure, a plurality of auxiliary light sources L1,L2 . . . LN may be controlled in combination so as to simultaneously emit light beams of different colors, thereby emitting light of a color different from that emitted from a single light source.

Next, how automatic focusing is performed in the photographing mode according to the present embodiment is explained hereunder, referring to FIGS. 3 through 16.

The present embodiment enables the photographer to use color data and auxiliary light in addition to normal brightness data in order to establish the lens position, in other words to achieve correct focusing. Furthermore, even if there is blur of the subject, the embodiment ensures correct focusing by dividing the image data into a plurality of windows.

First, how a device having the configuration that calls for dividing an image data into a plurality of windows functions in cases where there is no camera shake or the like causing blur of the subject is explained, referring to FIG. 3.

As shown in FIG. 3(a), the present embodiment calls for the image focusing area W to be situated at the center of the CCD 12 and divided into a total of nine portions, i.e. three portions horizontally by three portions vertically, so as to form windows W1-W9. However, the image focusing area W may consist of any appropriate number of windows, provided that each window is adjacent to a plurality of other image detecting areas. The subject T is positioned so that the windows W1-W9 sufficiently capture its contrast when there is no significant blur of the subject.

A result of evaluation of contrast in the state shown in FIG. 3(a) is represented by a curve Tc shown in FIG. 3(b). The example shown in FIG. 3(b) represents the final evaluated value resulting from summing up the evaluated values produced by evaluating multiple image data obtained by capturing the subject T with the optical system 11, which is driven by the motor 20 to move its focus from the short range (“NEAR”) to the long range (“FAR). FIG. 3(b) clearly shows that the subject distance Td is at the peak P of the evaluated values.

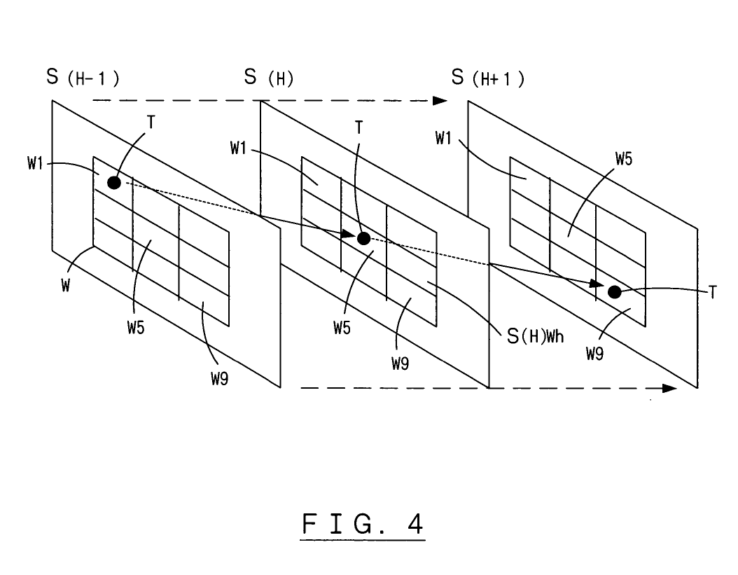

Next, the automatic focusing function in cases where there is blur of the subject due to camera shake or other causes is explained hereunder, referring to FIGS. 4 through 6.

First, referring to FIG. 4, an explanation is given of how a method that uses a plurality of image detecting areas copes with blur caused by camera shake, movement of the subject, or other similar causes.

FIG. 4 illustrates camera shake during automatic focusing, i.e. a situation where the image capturing apparatus 10 inadvertently moves relative to the subject T by showing images for focusing obtained by inputting image data while shifting the position of the lens of the optical system 11 in the process from a scene S(H−1) through a scene S(H) to a scene S (H+1) in time sequence. FIG. 4 shows as an example a case where a subject T is in the window W1 in the scene S (H−1). Upon occurrence of movement of the subject or camera shake, the part of the subject T with a large contrast moves to the window W5 in the scene S(H) and to the window W9 in the scene S(H+1). Therefore, should the contrast evaluated value be evaluated using only a specific window, e.g. the window W1, in this state, accurate evaluation cannot be performed.

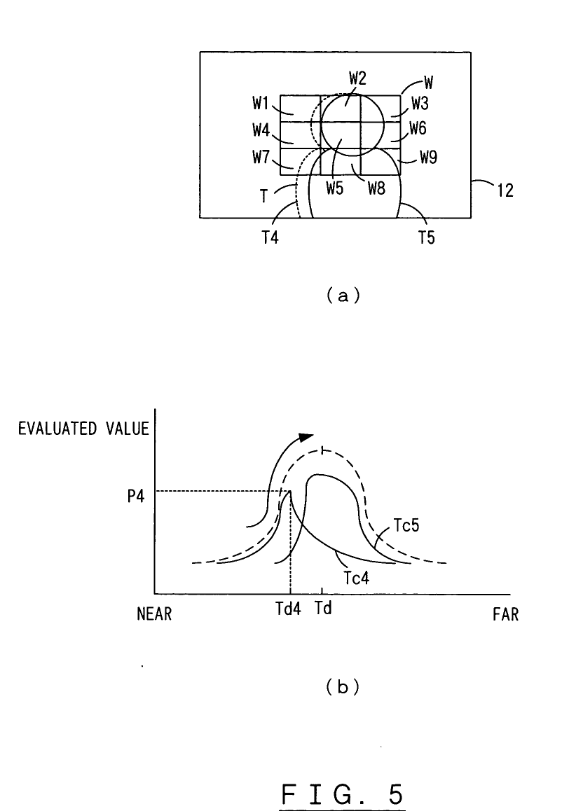

FIG. 5, too, illustrates a situation where camera shake occurs during automatic focusing. FIG. 5(a) shows an image focusing area W which is similar to the one shown in FIG. 3(a). In the image focusing area W shown in FIG. 5(a), however, the subject T appears to move from the position represented by the broken line T4 to the position represented by the solid line T5, thereby generating blur in which there appears to be movement, for example, relative to the windows W4,W5 on the part of the subject T with a large contrast from the window W4 to the window W5. Should focusing be performed by driving the lens of the optical system 11 during this movement of the subject T from the window W4 to the window W5, the evaluated value resulting from evaluation of the contrast of the window W4 and the evaluated value resulting from evaluation of the contrast of the window W5 are respectively represented by the curve Tc4 and the curve Tc5 as shown in FIG. 5(b). Now, let us take as an example the curve Tc4, which is the evaluated value for the window W4; the position Td4, which does not correspond to the actual subject distance Td serves as the peak P4 of the evaluated values, and employing the peak P4 may impair discrimination of a plurality of subjects located at different distances or cause other errors.

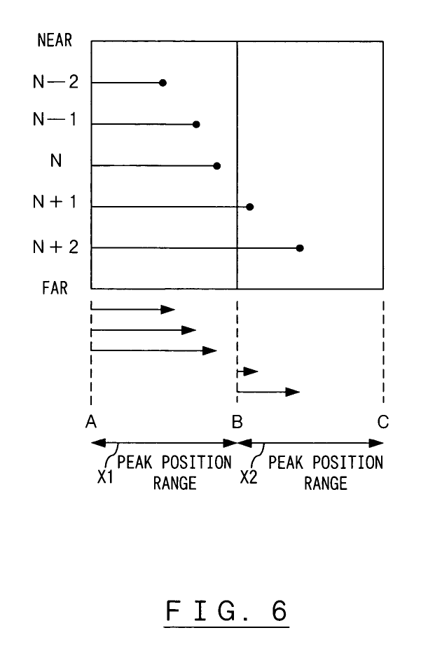

A peak position that appears to move in the windows W1-W9 is shown in FIG. 6. When the subject T is moving in the horizontal direction, the range of the peak position is determined by the number of pixels arranged along each horizontal line in each window W1-W9. X1 in FIG. 6 represents the peak position when the peak position reference point in the window W4 in FIG. 5(a) is denoted by A, and X2 represents the peak position when the peak position reference point in the window W4 in FIG. 5(a) is denoted by B. When the focal length, i.e. the lens position, of the optical system 11 is denoted by N, a range closer than N (towards NEAR) is denoted as N−1 and a range farther than N (towards FAR) is denoted as N+1. The point when the lens position of the optical system 11 moving towards FAR from N−1 reaches N+1 is when the peak position has moved from the window W4 into the window W5. In this state, blur of the subject can be easily detected even during automatic focusing, because the change in the peak position is obvious. Unless the portion with the high contrast moves across a plurality of windows, there are windows, e.g. the window W9, that have correct evaluated values even during occurrence of blur of the subject. Therefore, the correct peak position of the evaluated values can be calculated by detecting a portion where the peak position changes across a plurality of windows and reducing the weights on the evaluated values for the windows in which such a change has occurred.

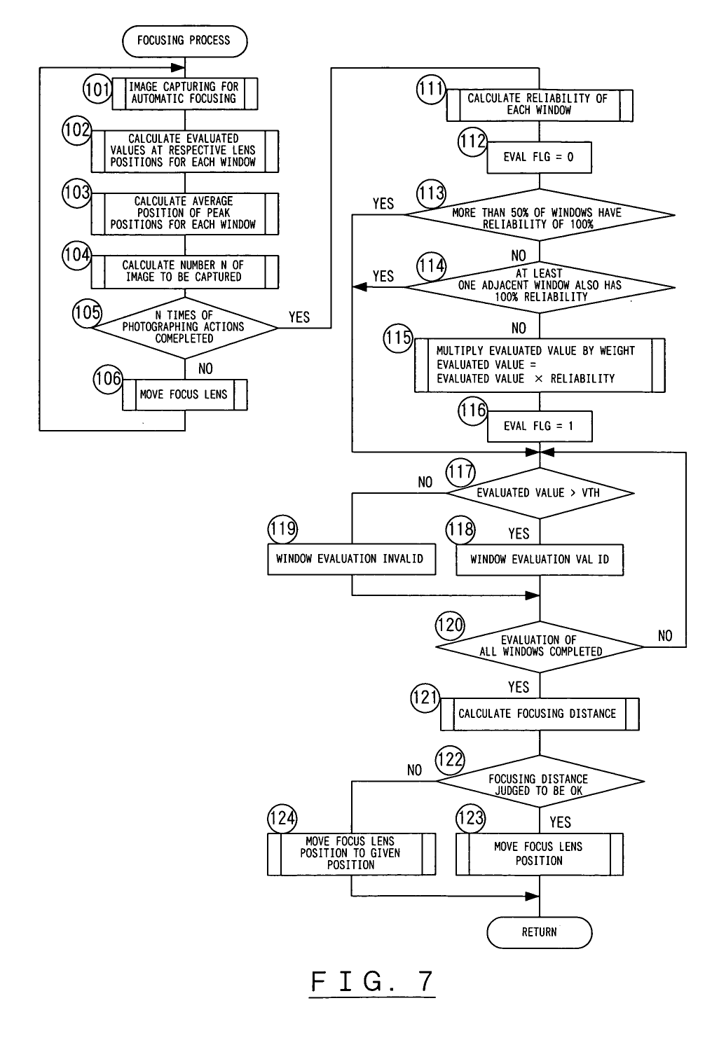

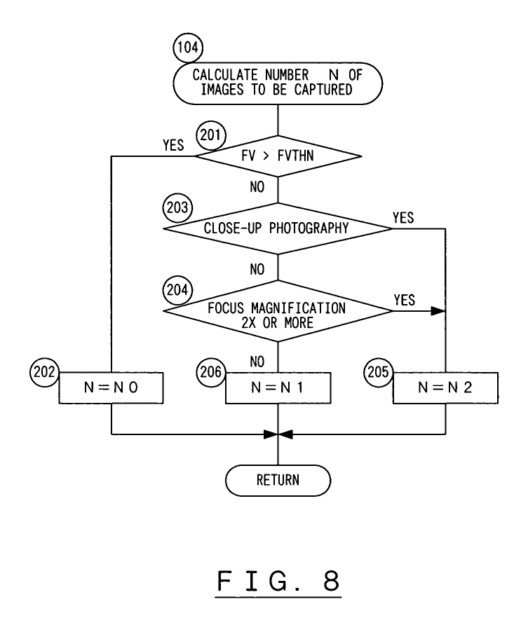

The present embodiment is based on the method of controlling automatic focusing that calls for weighting as described above. Therefore, in order to facilitate the explanation, said control method is explained hereunder, referring to flow charts shown in FIGS. 7 through 10. FIG. 7 shows the overall process of focusing, and each one of FIGS. 8 through 10 shows in detail a part of the focusing process shown in FIG. 7.

As shown in FIG. 7, multiple image data is used to perform focusing. First, in order to obtain image data of an image focusing area W, one frame of a picture is taken for automatic focusing processing at the initial position or the current position of the lens (Step 101). Using the data of the photographed image, a contrast evaluated value for each window W1-W9 of the image focusing area W is calculated (Step 102). When calculating each contrast evaluated value, peak values of all the lines in the each respective window W1-W9 are summed up. Then, the average position of the subject T is calculated by finding relative positions of each of the peak values of all the lines in each window W1-W9 from a reference position in the each respective window W1-W9 and summing up these relative positions (Step 103). The number N of frames to be photographed is calculated (Step 104), and until N times of photographing actions are completed (Step 105), photographing actions are repeated while moving the lens of the optical system 11 (Step 105). In other words, lens moving and picture taking for focusing are repeated N times (Steps 101-106) to obtain evaluated values of continuous image data.

In cases where the position of the lens driven in Step 106 is relatively close to the distance to the subject T, the average position calculated in Step 103 based on the image data captured for focusing in Step 101 sufficiently reflects the characteristics of the main contrast of the subject T. Therefore, especially in cases where camera shake or other incident causes movement of the subject in a window in which the camera position is close to the distance to the subject T, a change in the average of the peak positions is inevitable.

An explanation is now given of the process of calculating the number N of frames to be photographed for focusing (Step 104), referring to the flow chart shown in FIG. 8.

The purpose of setting the number N of frames to be photographed is to obtain sufficient essential image data by changing the number N of frames to be photographed based on the lens magnification of the optical system 11, the data of the distance to the subject T to be photographed, various photographing conditions set by the photographer, etc.

First, the evaluated value FV for each window W1-W9 calculated in Step 102 in FIG. 7 is compared with a given reference value FVTHn (Step 201). When the evaluated value FV is greater than the reference value FVTHn, N0 is input as N (Step 202). Step 201 may be omitted. N0 may be input as a variable based on the focus magnification for N. When the evaluated value FV is not greater than the reference value FVTHn (Step 201) in a situation where close-up photography is or has been chosen (Step 203) by the photographer who is operating the image capturing apparatus 10, or where the focus magnification is relatively large (for example 2× or more) (Step 204), N2 is input as N (Step 205). Under conditions other than those described above, in other words when the evaluated value FV is not greater than the reference value FVTHn (Step 201) in a situation where short-range photography is not chosen (Step 203) and where the focus magnification is relatively small (for example less than 2×) (Step 204), N1 is input as N (Step 206). The values N0,N1,N2 are smaller in the indicated order (N0<N1<N2). To perform short-range photography or when the focus magnification is large, meticulous evaluation is enabled by setting a large number N of images to be captured to provide minute setting for driving the lens of the optical system 11. On the other hand, when the subject T is located close to the optical system 11 (for example, when the calculated evaluated value FV is greater than a given reference value FVTHn), duration of focusing can be reduced by setting a small number N of images to be captured. In short, by providing a means to selectively set the lens driving range based on an evaluated value, the duration of focusing can be reduced without impairing precision of focusing.

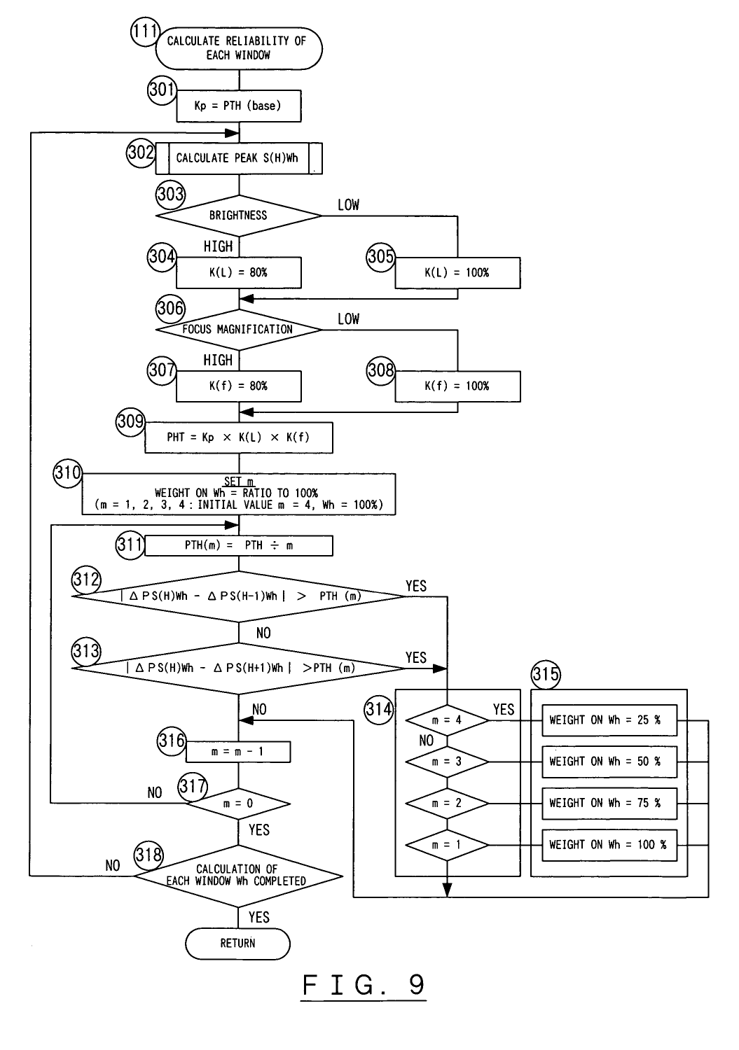

As shown in FIG. 7, judgment is made as to whether there is camera shake or like affecting an average position of the peak positions obtained through the N times of photographing actions, and the amount of the weight, which represents the reliability, to be placed on each window W1-W9 is calculated (Step 111). Next, how the determining circuit calculates the amounts of the weights is explained in detail, referring to the flow chart shown in FIG. 9.

First, Kp=PTH (base), which represents an initial value of the moving distance of peak value average positions (PTH) is set beforehand (Step 301). Then, each window Wh of the image focusing area W, in which a number of scenes are captured, is examined to determine a single or plural scenes S(H)Wh that presents the highest evaluated value (Step 302).

The peak value average position moving distance PTH is used as a final control value for selecting the amount of the weight on each window Wh. The peak value average position moving distance PTH is a variable that changes based on photographing conditions, such as the brightness, focal length, etc.

In cases where the brightness in a photographed scene is relatively high (Step 303), the moving distance in a window tends to be reduced because of an increased shutter speed. Therefore, in order to reduce the peak value average position moving distance PTH to a level lower than the preset initial value Kp=PTH(base), the ratio K(L) by which the initial value PTH(base) will be multiplied is set at, for example, 80% (Step 304). Should the brightness be not high, in other words, for example, should it be rather low (Step 303), the ratio K(L) is set at, for example, 100% (Step 305). In cases where the focus magnification is relatively high (Step 306), there is a higher possibility of camera shake than when focus magnification is low. Therefore, in order to reduce the peak value average position moving distance PTH to a level lower than the preset initial value PTH(base), the ratio K(f) by which the initial value PTH (base) will be multiplied is set at, for example, 80% (Step 307). Should the focus magnification be not high, in other words, for example, should it be rather low (Step 307), the ratio K(f) is set at, for example, 100% (Step 308).

The peak value average position moving distance PTH, which serves as the most appropriate control value for the photographed scene, is calculated by multiplying the preset initial value Kp=PTH(base) by ratios K(L),K(f), which have respectively been calculated as above based on the brightness and focus magnification (Step 309). In other words, calculation of the equation PTH=Kp×K(L)×K(f) is done. According to the present embodiment, the peak value average position moving distance PTH is calculated based on the brightness and focus magnification. However, incases where it is possible to find the most appropriate control value beforehand, the initial value PTH(base) of the peak value average position moving distance PTH may be directly used as the peak value average position moving distance PTH.

Next, the reliability of each window Wh is calculated, which begins with initialization of an amount of weight, i.e. a weighting factor (Step 310). The weighting factor is represented in terms of proportion to 100%. For example, the weighting factor may be initialized at 100%. At the same time, a variable m is provided with respect to the calculated peak value average position moving distance PTH so that the weighting factor can be set as a variable. For example, in cases where the weighting factor can be set at four levels, m may be 4, 3, 2, or 1, with 4 being the initial value.

When determining the amount of the weight, the ratio to the calculated peak value average position moving distance PTH is set as a changeable value, i.e. a peak value average position moving distance PTH (m), by using the variable m (Step 311). To be more specific, the peak value average position moving distance PTH(m) is found by dividing the peak value average position moving distance PTH calculated in the previous step by the variable m.

When the difference in the absolute value between the peak value average position ΔPS(H)Wh in the scene S(H)Wh and the peak value average position ΔPS(H−1)Wh in the previous scene S(H−1)Wh is greater than the peak value average position moving distance PTH(m), the CPU 17 serving as the determining means judges that camera shake or other similar incident has caused the subject T to move across windows W1-W9 or affected the calculation of the evaluated value (Step 312). When the difference in the absolute value between the peak value average position ΔPS(H)Wh in the scene S(H)Wh and the peak value average position ΔPS(H+1)Wh in the subsequent scene S(H+1)Wh is greater than the peak value average position moving distance PTH (m), the determining means also judges that camera shake or other similar effect has caused the subject T to move across windows W1-W9 or exerted an influence on the calculation of the evaluated value (Step 313). In cases where neither difference in the absolute value exceeds the peak value average position moving distance PTH (m), the determining means judges that there is neither camera shake nor an unfavorable influence on calculation of the evaluated value and, therefore, does not reduce the weighting factor for the pertinent window Wh. The greater the variable m, the smaller the peak value average position moving distance PTH(m) used in comparison, making it more difficult to determine the peak value average position moving distance. The weighting factors to be used are set based on the corresponding peak value average position moving distance PTH(m) (step 315). Should the difference in the absolute value be found to be greater than the set peak value average position moving distance PTH(m) in Step 312 or Step 313, the weighting for the corresponding window Wh is reduced by reducing the weight factor, which is based on the assumption that camera shake is present (Step 315). At that time, the weight factor may be reduced to, for example, as low as 25%. Comparison described above is repeated with the value of the variable m being reduced one at a time from the initial value, e.g. 4 (Step 316), until the variable m becomes 0 (Steps 311-317), while determining the amount of the weight based on each variable (314,315). Although the minimum weighting factor is set at 25% according to the present embodiment, the weighting factor is not limited to this particular value; for example, the minimum weighting factor may be set at 0%. Furthermore, according to the present embodiment described above, the peak value average position moving distance PTH(m) is a proportion to the peak value average position moving distance PTH calculated in the previous step. However, a plurality of optimum control values set beforehand may be used if it is possible.

By thus determining whether there has been camera shake by a plurality of criteria, the reliability can be exact and multiple levels.

The operation described above is repeated until calculation for every window W1-W9 is completed (Steps 301-318). By means of weighting described above, the reliability of each window W1-W9 is put into numerical form as a weighting factor.

By applying the process described above to the windows adjacent to the relevant window S(H)Wh, it can be ascertained whether there has been any influence of camera shake or other movement of the target that forms a peak. To be more specific, after the weighting factor, i.e. reliability, of each window Wh is calculated as shown in FIG. 7, Eval FLG is set at 0 (Step 112). Thereafter, in cases where the number of windows Wh with a weighting factor or reliability of at least 100% is not less than a given level, e.g. 50% of all the windows (Step 113), or in cases where there are adjacent windows Wh, each of which has a reliability of not less than a given level, e.g. 100% (Step 114), the determining means judges that there is no movement of the subject T in the pertinent scene. Therefore, without performing weighting of evaluation which will be described later, the determining means performs validity determination by comparing the evaluated value with a preset control value (Step 117).

Should neither condition stipulated in Step 113 or 114 be fulfilled, calculation using weighting factors is performed as described hereunder. After the weighting factors for the windows W1-W9 are calculated, the entire evaluated values of each window W1-W9 are multiplied by the weighting factor calculated for the corresponding window so that weight on each evaluated value reflects on the evaluated value itself (Step 115). At that time, in order to show that calculation using a weighting factor has been performed, Eval FLG is set at 1 (Step 116).

Then, each weighted evaluated value is compared with a preset control value VTH to determine whether it is greater than the control value (Step 117). Thus, a process to determine whether it is valid as an evaluation target (Step 118) or invalid (Step 119) is conducted for every window W1-W9 (Steps 117-120).

Should a plurality of windows found to be valid, the CPU 17 finds a focusing distance by performing focusing distance calculation based on focusing positions, i.e. partial focusing distances, of the valid windows (Step 121).

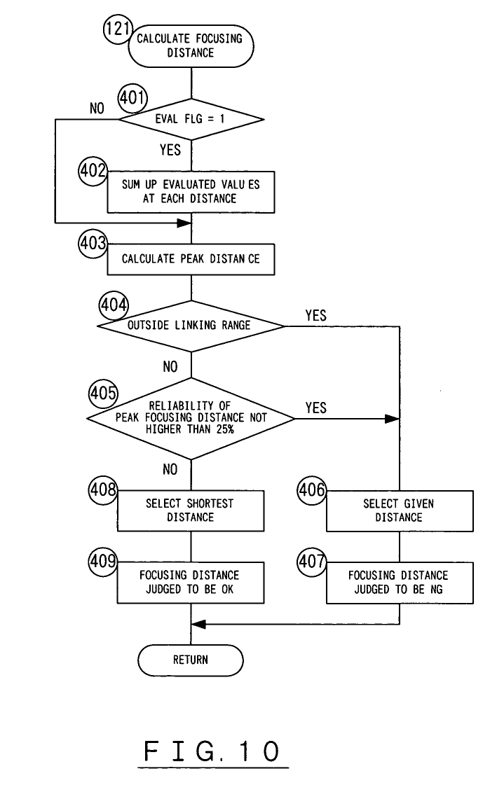

The focusing distance calculation is shown in detail in FIG. 10. First, whether calculation using a weighting factor has been performed is determined from the state of Eval FLG (Step 401). In cases where weighting has been performed, the weighted evaluated values are summed up at each distance (Step 402). In cases the evaluated values have not been weighted# summation is not performed. Peak focusing positions, i.e. peak positions, are calculated from the evaluated values (Step 403). In cases where all the peak focusing positions are outside a given photographing range, i.e. a linking range (Step 404), or every peak focusing position has a reliability not higher than a given level, e.g. 25% (Step 405), it is judged that calculation of the subject distance is impossible. In this case, the focusing position, i.e. the focal point at which the lens will be focused, is compelled to be set at a given value, which has been set beforehand (Step 406). At that time, focusing distance determination is judged to be NG (Step 407).

In a situation other than the above, in other words, in cases where one or more peak focusing positions (peak positions) are in the given photographing range (Step 404) and such peak focusing position(s) have a reliability greater than a given level, e.g. 25% (Step 405), it is judged that calculation of the subject distance is possible and, from among the valid windows W1-W9, the partial focusing position having the peak position at the closest focusing distance is chosen as the focusing position (Step 408). At that time, focusing distance determination is judged to be OK (Step 409).

When the focusing distance calculation described above includes weighting, the evaluated values are summed up in Step 402 to produce a single evaluated value so that the resulting peak position represents the position of the center of gravity of plural evaluated values. However, the invention is not limited to such a configuration; it is also possible to choose only the windows whose peak positions are at a close distance, perform summation for each window, then calculate the partial focal point position, and set it as the focusing position. In cases where weighting has not been performed, it is also possible to choose the partial in-focus position at the closest distance from the windows W1-W9 that hold valid evaluated values, and set the partial focal point position as the focusing position.

Based on the result of determination of focusing distance, (Step 407 or 409) which has been obtained by the focusing distance calculation described above (Step 121), judgment is made as to whether the result of focusing distance determination is OK or NG as shown in FIG. 7 (Step 122). If the result is OK, the lens of the optical system 11 is moved to the set focusing position (Step 123). In case of NG, the lens of the optical system 11 is moved to the aforementioned preset focusing position (Step 124). Thus, the lens can be positioned at the final focusing position.

The device described above is an automatic focusing device used in an image capturing apparatus, such as a digital camera or a video camera and uses image data to perform automatic focusing by a method which calls for dividing a frame into a plurality of areas and determining a focusing position in each area. Even for a scene containing an obstruction to range finding, such as movement of the subject or camera shake, the device according to the embodiment is capable of appropriate range finding and focusing the optical system 11 by detecting blur and using only the optimal data.

To be more specific, when peaks of evaluated values for respective plural areas have been calculated, a conventional device may simply use as the focusing position the partial focal length that is the focusing position at which the highest evaluated value has been recorded. However, by means of evaluated value weighting that takes into account the reliability of the evaluated values, the device according to the invention eliminates partial focal lengths obtained from windows having low reliability due to camera shake or other causes, uses only reliable evaluated values, even if they are not the highest values, to make a judgment and selects the partial focal length at the closest distance from among the evaluated values that have been ascertained to be valid. By using this method, which increases the probability of accurate focusing, the device is capable of making accurate judgment of the focusing position and thereby enables in-focus photography. The device according to the embodiment is particularly valid when used in an optical system 11 of a so-called high-magnification type having a high zooming ratio.

Should the evaluated values themselves prior to weighting be low (e.g. evaluated values affected by noises or other factors or evaluated values in windows in which there is no valid subject), the embodiment is capable of accurate detection of the focal length by treating such windows to be invalid.

To be more specific, giving priority to the short range when calculating a plurality of focal lengths in a plurality of areas is a method generally deemed effective. However, should there be an erroneous peak at a distance shorter than the subject distance due to movement of the subject or camera shake, giving priority to the short range through a conventional process may prevent the location of the subject from being recognized as the focusing position and, instead, cause the erroneous peak to be determined as the focusing position, resulting in failure in setting the correct focusing position. Even if there is an erroneous peak at a distance shorter than the subject distance due to movement of the subject or camera shake, the device according to the embodiment is capable of detecting the movement of the subject or camera shake and using only the optimal data and thereby reliably setting an appropriate focusing position while giving priority to the short range.

There is a conventional method that calls for correcting blur of an image of the subject or camera shake by changing the image detecting area and performing evaluation of the focal point again after the change of the image detecting area. Such a method presents a problem in that it takes a long time to complete calculation of the focusing position, resulting in a missed picture-taking opportunity. The constitution described above, however, enables rapid processing and capture of the shutter release moment, because the focusing position is calculated solely from the information obtained from preset image detecting areas.

By eliminating the need of an acceleration sensor or any other special device or equipment for detecting blur of an image of the subject or camera shake, the embodiment simplifies the structure of the automatic focusing device and thereby reduces its production costs.

By increasing the reliability of the calculated plural subject distances, the embodiment makes it possible to devise other algorithms.

As a focal point position is calculated based on evaluated values obtained from preset image detecting areas, the user can avoid any discomfort that would otherwise be felt from the lens focusing on an untargeted subject.

As the device is not affected by change in the brightness of images having flicker from such sources as a fluorescent lamp or the like and is therefore free from the problem of fluctuation in peak positions of evaluated values of the image, the device according to the embodiment is capable of evaluating the reliability of each one of the plural areas regardless of each evaluated value.

The embodiment described above employs a so-called hill-climbing search range finding method, which calls for obtaining evaluated values at a plurality of positions while operating the optical system 11, and recognizing a peak at the point when the curve of evaluated values changes from upward to downward. Should blur of a subject image occur, the peak position of each window moves inside the window and then into an adjacent window W1-W9. When the peak position of the contrast of the subject T moves from one window to another, the peak value of the evaluated values for the first-mentioned window decreases sharply. By reducing the weight on any window of which there has been a sudden change in the evaluated values with respect to a scene captured previously or immediately afterwards, the embodiment ensures elimination of data containing influence of camera shake and enables the accurate range finding and focusing, using only the most appropriate data.

The method described above calls for summation of the peak positions of the evaluated values. There is a variable in the peak positions of a relatively unfocused image. Therefore, according to the above method, the weight can be reduced when given to a window having a wide variable in the peak positions or having low peak values from the beginning.

As described above, at each change of the lens position of the optical system 11, the focusing device using the above method measures either the difference between peak values of evaluated values in the same window or the difference in the moving distance between the average position of the peak positions in one window and the average position of the peak positions in an adjacent window, or measures both kinds of differences. By performing this measurement, the device determines the reliability of the evaluated values of the pertinent window, thereby increasing the reliability of the window. Therefore, in cases where the short range is selected from among focal point positions in a plurality of areas at the time of deciding a final focusing position, range finding is performed with an increased reliability even if camera shake or movement of the subject should occur.

With the features as above, even if there is blur of the subject, the reliability of focusing can be increased.

Although the invention is explained referring to the constitution that copes with horizontal movement of a subject T, the invention is also applicable to devices that cope with vertical or diagonal movement of a subject or any combination of these movements.

The image processing circuit 15 shown in FIGS. 1 and 2 may be formed of the same chip as that of another circuit, e.g. the CPU 17, or executed by the software of the CPU 17. By thus simplifying the circuits, their production costs can be reduced. The filter circuits 32 of the image processing circuit 15 may be in any form, provided that they are capable of detecting contrast.

The range finding is not limited to the aforementioned hill-climbing search method and may be executed by scanning the entire range in which the automatic focusing device can operate.

Other than the procedure described above, it is also possible to sum up the evaluated values of a plurality of adjacent windows, after the weighting process shown in FIG. 9. Weighting may also be performed after summation of the evaluated values for a plurality of selected windows.

According to the method described above, one each value is set as the peak value average position moving distance PTH and the control value VTH for the process shown in FIGS. 7 and 9. However, it is also possible to determine these values by selecting from among a plurality of preset values. Furthermore, these values may vary depending on the largeness of the evaluated values or various photographing conditions including the brightness and data of the optical system 11, such as the shutter speed, focus magnification, etc. If such is the case, the optimal values may be selected based on these conditions or found by calculation using these conditions and data as variables in order to perform evaluation suitable for each scene.

When taking a picture using an electronic flash, by obtaining image data of respective scenes with the electronic flash emitting light in sync with each picture taking for focusing, a focusing distance can be detected by the focal length detecting method described above. When an electronic flash is used together with a device according to the invention, photographing is performed under control of light emission from the electronic flash based on the focusing distance and control of quantity of light, i.e. control of the aperture of the camera, shutter speed, etc.

The method described above chooses the partial focal length at the closest distance, i.e. the partial focusing position having the peak position at the closest distance, from among the valid evaluated values, and sets such a partial focusing position as the focusing position (Step 408). However, the invention is not limited to such a process; in accordance with the intention of the user (to be more specific, in response to operation by the user, i.e. the photographer, to select the photographing mode), a partial focusing position other than the closest partial focusing position may be selected as the focusing position directly by the photographer or automatically as a result of selecting function of the control means in response to operation by the photographer. Furthermore, according to the method, when the result of focusing distance determination is NG (Step 122), the lens of the optical system 11 is moved to a preset focusing position (Step 124). However, it is also possible to set a plurality of focusing positions beforehand and move the lens of the optical system 11 to one of the present focusing positions in accordance with the intention of the photographer, i.e. operation by the photographer to select the photographing mode.

The focal length detecting method described above calls for setting a plurality of image detecting areas adjacent to one another, obtaining multiple image data while changing the focal length of an optical system, calculating from said multiple image data a partial focal length for each image detecting area based on which image data the peak value of contrast evaluated values has been recorded in, calculating the reliability of each image detecting area based on the position at which said peak value has been recorded moving across the multiple image data, and selecting a focal length from a group consisting of said partial focal lengths and at least one given focal length, said focal length selected based on the reliability and the evaluated values of each respective image detecting area. As each reliability is calculated based on the position at which the peak value of the contrast evaluated values has been recorded moving across the multiple image data so that the partial focal length of an image detecting area that has a low reliability due to relative movement of the subject is excluded from selection, the method described above enables the accurate detection of the focal length.

According to the focal length detecting method, weighting of evaluated values is performed based on the calculated reliability, and a focal length is selected from among the partial focal lengths of the image detecting areas based on the evaluated values thereof to which weighting has been applied. By using evaluated values to which weighting has been applied based on a calculated reliability so that the partial focal length of an image detecting area having a low reliability is excluded from selection, the method described above enables the accurate detection of the focal length.

According to the focal length detecting method, should a position at which a peak value has been recorded move from at least one image detecting area that contains said position into at least one other image detecting area, the reliability of the first-mentioned image detecting area is reduced. With the feature described above, the aforementioned method enables the accurate detection of the focal length by excluding the partial focal length of an image detecting area having a low reliability due to relative movement of the subject from selection.

According to the focal length detecting method, should a position at which a peak value has been recorded move more than a given distance across plural image detecting areas that contain said positions at which peak values have been recorded, the reliability is reduced. With the feature described above, the aforementioned method enables the accurate detection of the focal length by excluding the partial focal length of an image detecting area having a low reliability due to relative movement of the subject from selection.

According to the focal length detecting method, in cases where image data containing a great peak value has been obtained, the number of images to be subsequently obtained as data is reduced. With the feature described above, the method enables the reduction of time needed for focusing by obtaining only sufficient essential image data.

According to the focal length detecting method, a peak position movement determining value, which is used at the time of calculation of a reliability for determining whether a position at which a peak value has been recorded has moved is a variable calculated based on photographing conditions. With the feature described above, the method enables the detection of an appropriate focal length by setting a peak position movement determining value based on photographing conditions, thereby enabling calculation of a reliability factor more appropriate for the photographing conditions.

According to the focal length detecting method, a plurality of peak position movement determining values are set for determining at the time of calculation of a reliability whether a position at which a peak value has been recorded has moved, and the peak position movement determining values are sequentially compared with the multiple image data. By setting a plurality of peak position movement determining values and sequentially comparing these values with the image data, the method having this feature enables the setting of reliability in a plurality of levels and thereby ensures detection of an appropriate focal length.

The focusing device described above comprises an image pickup device, an optical system for forming an image on the image pickup device, an optical system driving means for changing the focal length of the optical system, and an image processing means for processing image data output from the image pickup device and controlling the optical system driving means, wherein the image processing means is adapted to obtain multiple image data while changing the focal length of the optical system by controlling the optical system driving means, define a plurality of image detecting areas adjacent to one another in each one of the multiple image data obtained as above, calculate a partial focal length for each image detecting area based on which image data the peak value of contrast evaluated values has been recorded in and also calculate the reliability of each image detecting area based on the position at which said peak value has been recorded moving across the multiple image data, and select a focal length from a group consisting of said partial focal lengths and at least one given focal length, based on the reliability and the evaluated values of each respective image detecting area. As each reliability is calculated based on the position at which the peak value of the contrast evaluated values has been recorded moving across the multiple image data so that the partial focal length of an image detecting area having a low reliability due to relative movement of the subject is excluded from selection, the device described above is capable of selecting an accurate focal length and appropriate focusing.

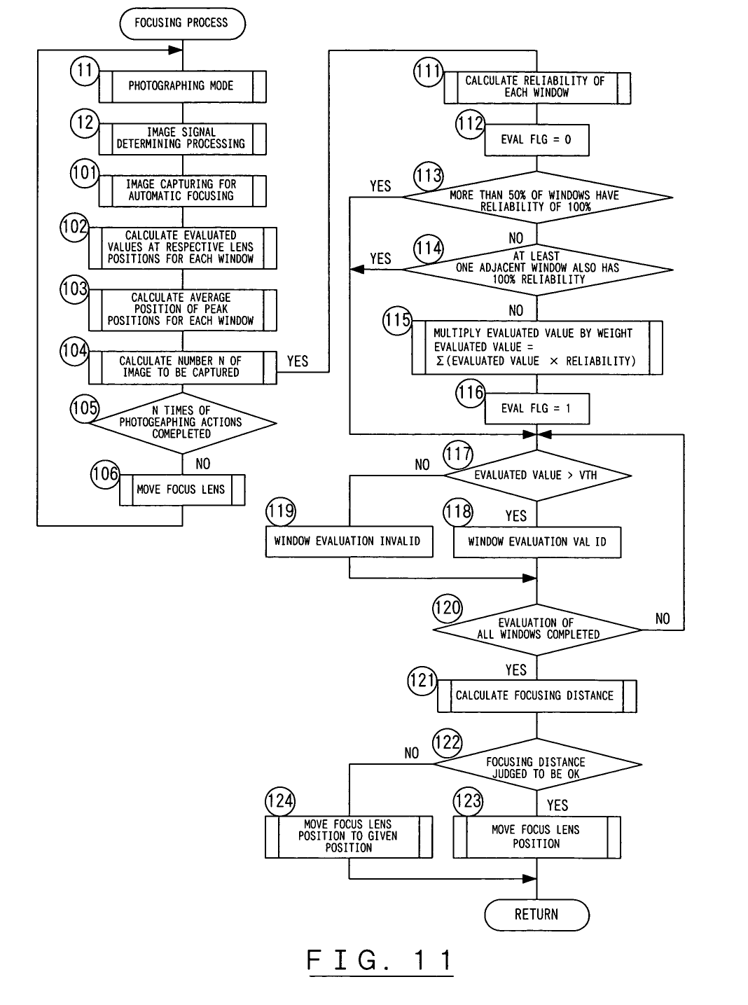

Next, a focal length detecting method and a focusing device according to the present embodiment of the invention are explained, referring to FIGS. 11 through 16.

This embodiment is based on the method described above and shown in FIGS. 7 through 10. According to this embodiment, the photographer is allowed to select image data to be used for establishing the lens position, in other words final determination of the focal length. The photographer is enabled to make this selection automatically or manually from among RGB image data consisting of Red signals (R), green signals (G) and blue signals (B), in addition to brightness data, i.e. image data representing normal YCC brightness data. Furthermore, in addition to the short-range priority mode (the normal mode), which is a normal photographing mode, the photographer may also select the long-range priority mode; the photographer may even designate a desired range of photographing distance, i.e. a linking range, by means of a mode that can be called a far distance mode or an infinity mode. In the description hereunder, the explanation of the same elements or components as those of the constitution shown in FIGS. 1 though 10 is omitted.

The device according to the present embodiment includes an operating means for determining whether selection of image data (brightness data or color data) to be used for determining the focal length is made automatically or manually by the photographer, an operating means for setting, in cases where manual operation has been selected, which color will be used for determining the focal length, and an operating means which is a photographing mode selecting means to permit the photographer to choose the long-range priority mode or the far distance mode. Its function is similar to the function of focusing shown in the flow chart of FIG. 7 except that, as shown in FIG. 11, setting of a desired photographing mode (Step 11) and image signal determining processing (Step 12) are performed prior to taking a picture for automatic focusing processing (Step 101) and that the details for calculation of the reliability of each window (Step 111) and focusing distance calculation (Step 121) are different. Said calculation of the reliability of each window is performed in order to determine the amount of the weight to be placed on each evaluated value used for calculation of the focal length for the image data selected by the image signal determining processing.

First, an explanation is given of the process of setting the desired photographing mode. When focusing process involves designation of a range of photographing distance, it is necessary to know, as criteria for focusing, the range of photographing distance through the lens driving range based on the photographing modes of the image capturing apparatus 10. Should the photographing modes of the image capturing apparatus 10 include a normal mode which covers, for example, 50 cm to the infinity, the lens driving range is set for this mode. If the image capturing apparatus 10 has other modes than the normal mode, such as a far distance mode (an infinity mode), a macro mode, etc., an operating means to enable the photographer to select any of these modes, in other words an operating means that enables the photographer to set the range of photographing distance, i.e. the lens driving range, is provided.

In the process of focusing, whether determination of the final focal length gives priority to the short range or the long range has to be decided as criteria for focusing. This is determined by the photographer selecting a photographing mode by operating the operating means of the image capturing apparatus 10. Should the photographing mode of the image capturing apparatus 10 be set at the long-range priority mode, setting is made to employ a longest-distance selecting mode for driving the lens so that the focusing distance corresponds to the longest distance in a captured image. In cases where the short-range priority mode has been selected, the focusing device is set at the shortest-distance selecting mode so that the focusing distance corresponds to the shortest distance in a captured image, thereby enabling photography with priority given to the short range, which is the mode generally employed.

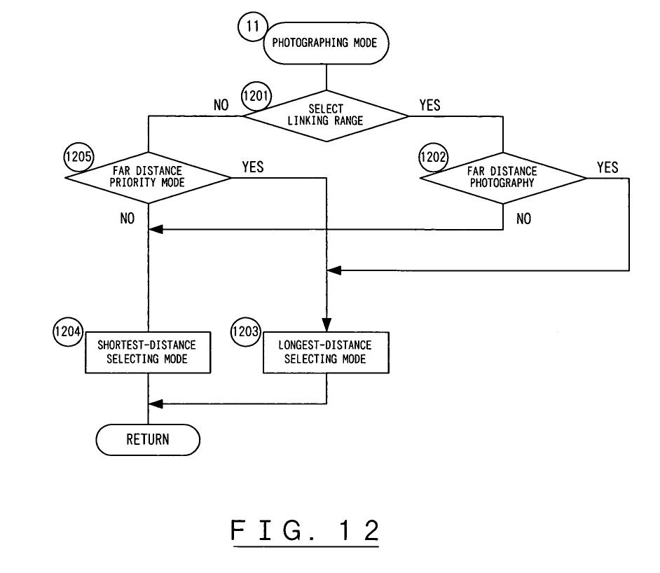

The process of setting the desired photographing mode shown in FIG. 11 (Step 11) begins with ascertaining whether the photographer has designated the range of photographing distance as shown in FIG. 12 (Step 1201). In cases where the mode for selecting the range of photographing distance has been selected, judgment is made as to whether the far distance photographing mode has been selected (Step 1202). In cases where the far distance mode has been selected, the longest-distance selecting mode is selected (Step 1203). In cases where the far distance mode has not been selected (in other words when either the macro mode or the normal mode has been selected), the shortest-distance selecting mode is selected (Step 1204). In short, the photographing mode, i.e. whether priority is given to the short range or the long range, is automatically decided in these steps based on the range of photographing distance.

In cases where the mode for selecting the range of photographing distance has not been selected in Step 1201, judgment is made as to whether long-range priority mode has been selected (Step 1205). If the photographer has selected the long-range priority mode, the longest-distance selecting mode is selected (Step 1203). In cases where the long-range priority mode has not been selected, the shortest-distance selecting mode is selected (Step 1204). In other words, the photographing mode that will determine the final focusing distance with priority on the intention of the photographer is selected in these steps.

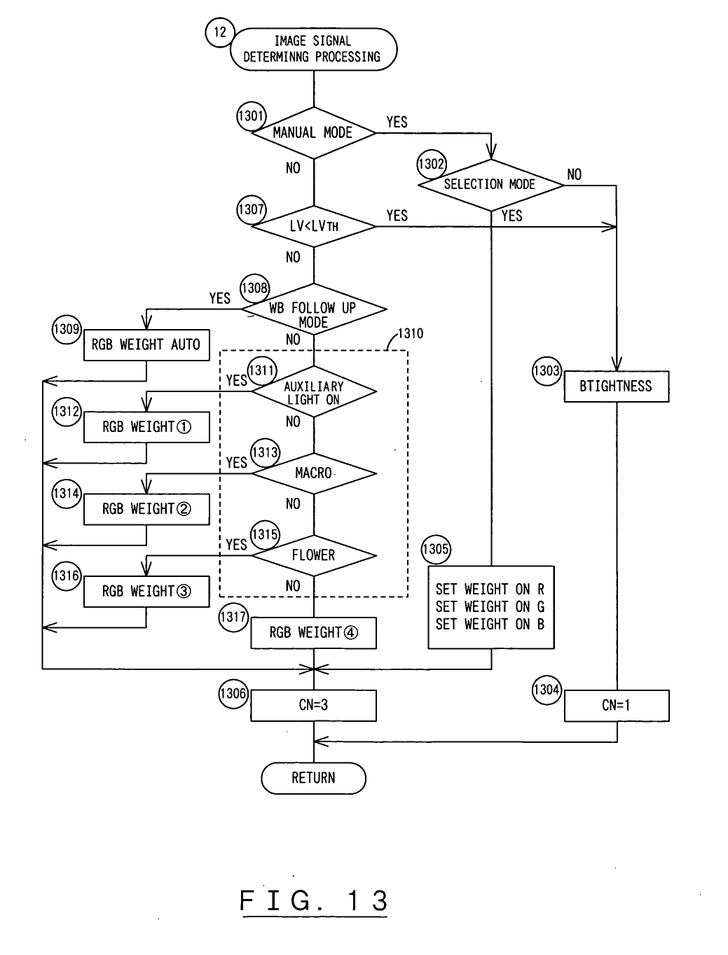

The image signal determining processing (Step 12) shown in FIG. 11 is for making selection between a manual mode and an automatic mode to be used in the focusing process from Step 11 to Step 106 in FIG. 11. The aforementioned manual mode is for the photographer to manually select brightness data or color data based on the subject or other conditions, whereas the automatic mode calls for the image capturing apparatus 10 to perform the selection automatically. The image signal determining processing, which is shown in FIG. 13 in detail, begins with ascertaining whether the photographer has chosen the manual mode for using either the brightness data or the color data from the image data information (Step 1301). In cases where the manual mode has been selected, judgment is made as to whether the photographer has chosen the mode for using the color data (Step 1302). In cases where the color data is not going to be used, the device is automatically switched to the mode for using only the brightness data (Step 1303). As the RGB color data is not going to be used, the variable CN is stored as 1 (CN=1) (Step 1304). In cases where the mode for using the color data rather than the brightness data for focusing has been selected in Step 1302, the device is enabled to put into numerical form a desired amount of weight to be placed on the color data of each RGB color. The numerical values will be used as set values in calculation of a focal length (Step 1305). For example, in cases where selection has been made so as to use the color data of the three RGB colors, the variable CN, which represents the number of color data items, is stored as 3 (CN=3) (Step 1306). Settings of the matrix complementary circuit 27 and the switch 28 shown in FIG. 2 are made based on setting of the color data or the brightness data, such as the variable CN described above.

In cases where the manual mode has not been selected in Step 1301, the device functions in the automatic mode for automatically selecting color data or brightness data. In the automatic mode, the first procedure is to examine the value of brightness in the photographing environment (Step 1307). Should the current brightness value LV be lower than a preset brightness value LVTH, it is decided that the brightness data alone should be used as the image data for focusing due to the lack of color data, resulting in the subsequent progression to Step 1303. In cases where availability of the color data has been ascertained in Step 1307, weighting factors for the respective RGB colors are automatically set based on various settings, such as the photographing mode set in Step 11.

In cases where a white balance follow-up mode has been chosen (Step 1308), the weights on the information of each RGB color is automatically set based on the current information regarding the subject, such as the color data and the white balance WB (Step 1309). For example, in cases where it has been judged that the subject contains a relatively large amount of red (R), the weights to be placed on evaluated values are calculated so that a greater value is set as a weight on R while relatively small values are set as the weighting factors for green (G) and blue (B).

Although it is not shown in the drawings, in cases where setting of a plurality of image areas is permitted, it is also possible to detect color data in each one of the image areas and set a great weight on the color with the greatest value.

Furthermore, weights on evaluated values may be set so as to deal with any one of a plurality of photographing modes other than those set in Step 11 (Step 1310).

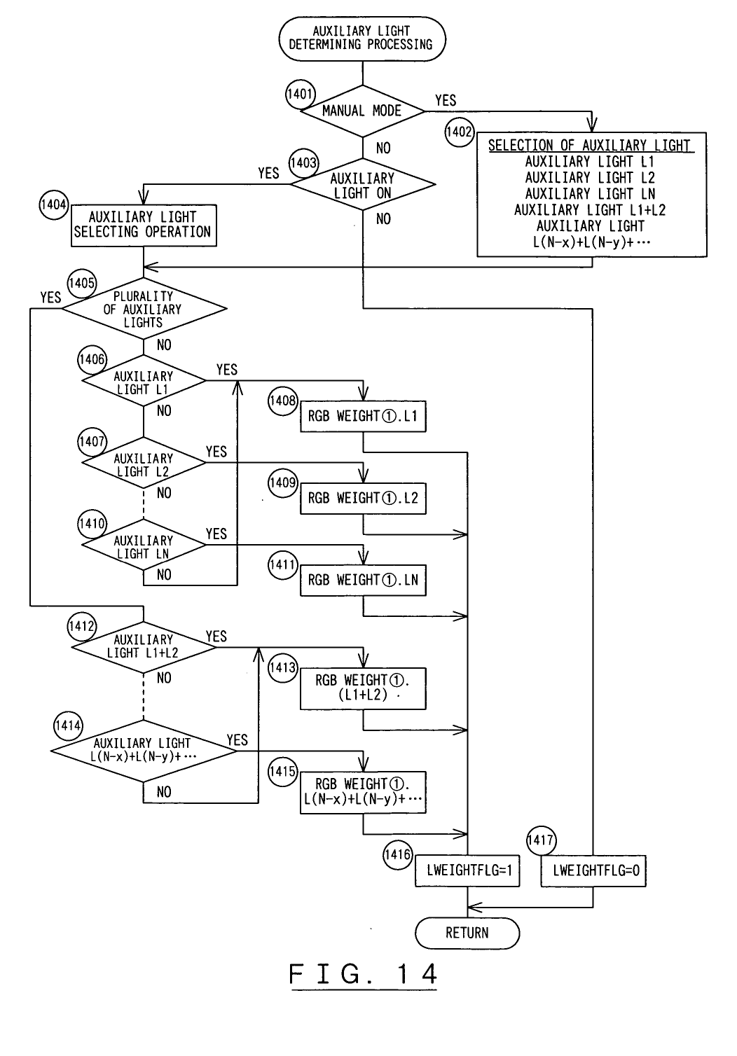

For example, in the case of the present embodiment, which is provided with an auxiliary light device 23, based on the settings for control of light emission from the auxiliary light sources L1,L2 by the auxiliary light device 23 (Step 1311), the prescribed weight for each respective RGB color data is set either automatically or manually (Step 1312,1305). An auxiliary light determining processing, which controls the auxiliary light sources L1,L2, is explained in detail, referring to FIG. 14. When selecting the photographing mode, the photographer can choose whether to cause the auxiliary light sources L1,L2 to emit light manually or automatically (Step 1401). In cases where the manual mode has been selected in Step 1401, a single light source or a combination of light sources L1,L2 are selected from among the plurality of auxiliary light sources L1,L2 of auxiliary light device 23 of the image capturing apparatus 10 so that the selected light source(s) L1,L2 will emit light in accordance with the selection of the photographer (Step 1402). In cases where the manual mode has not been selected in Step 1401, the device functions in the automatic mode to automatically cause the auxiliary light source(s) L1,L2 to emit light when it is necessary (Step 1403). Whether or not light emission from the auxiliary light source(s) L1,L2 is necessary is judged by the CPU 17 based on the brightness data or other relevant information. When automatically causing the auxiliary light source(s) L1,L2 to emit light, the CPU 17 performs calculation based on information of the subject, such as brightness data or color data (Step 1404), to make judgment as to what color of auxiliary light L1,L2 is appropriate. As a result of the automatic calculation or the manual setting, judgment is made as to whether light emission from a plurality of auxiliary light sources L1,L2 is necessary. In cases where light emitted from a single auxiliary light source L1,L2 is sufficient, the optimal amount of weight to be placed on the evaluated value of each RGB color data is selected to obtain the maximum evaluated value (Step 1408 or 1409) based on the color data of the light from the selected auxiliary light source L1,L2, i.e. either the first auxiliary light source L1 (Step 1406) or the second auxiliary light source L2 (Step 1407).

It is also possible to use three or more auxiliary light sources L1,L2 . . . LN and set an appropriate weight for each respective auxiliary light source L1,L2 . . . LN (Steps 1410,1411). Should the color data of each auxiliary light source L1,L2 . . . LN remain undetermined, it must be processed as an error. If such is the case, the amount of the weight is set as if it were set for the first auxiliary light source L1, which is the normal auxiliary light source (Step 1408). The process when a plurality of auxiliary light sources L1,L2 are caused to emit light either manually or automatically (Step 1405) is now explained. For example, when causing the first auxiliary light source L1 and the second auxiliary light source L2 to emit light simultaneously (Step 1412), the optimal amount of weight to be placed on the evaluated value of each RGB color data is selected to obtain the maximum evaluated value (Step 1413) based on the color data of the light resulting from simultaneous light omission from the auxiliary light sources L1,L2. When causing an N number of auxiliary light sources L1,L2 . . . LN in combination to emit light (Step 1414), the amount of the weight for each respective auxiliary light source L1,L2 . . . LN to obtain the optimal result of the combination of these auxiliary light sources is selected (Step 1415) in the same manner as in the case of causing a combination of two auxiliary light sources L1,L2 to emit light. Should the color data of the combination of auxiliary light sources L1,L2 . . . LN remain undetermined, it must be processed as an error as is the case of a single auxiliary light source L1,L2 . . . LN emitting light. If such is the case, the amounts of the weights are set as if the combination of the lights sources consisted of the first and second auxiliary light sources L1,L2, which is the normal combination of auxiliary light sources (Step 1413). When at least one of the auxiliary light sources L1,L2 . . . LN is going to be caused to ultimately emit light, the variable LweightFlg is stored as 1 (Step 1416). When none of the auxiliary light sources L1,L2 . . . LN is going to emit light, the variable LweightFlg is stored as 0 (Step 1417). Then, the auxiliary light determining processing returns to the flow chart shown in FIG. 13. In cases where light is emitted from at least one of the auxiliary light sources L1,L2 . . . LN in the photographing mode (Step 1304) in the flow chart shown in FIG. 13, the variable LweightFlg is used for determining whether the setting of the amount(s) of the weight(s) described above has been completed.

In cases where light emission from the auxiliary light sources L1,L2 . . . LN is not selected (Step 1311), and the photographing range is short, in other words when performing macro photography (Step 1313), it can be assumed that the color data of the subject contains relatively vivid colors. Therefore, the amount of the weight for every RGB color data is set so that each RGB color is given a great weight (Step 1314).

Should the target of the photograph be limited to a specific subject, the amounts of the weights are set so as to facilitate focusing on the subject and also substantially reduce the possibility of focusing on the colors of any other objects that are expected to be near the subject. For example, should a mode for specifying flowers as the subject have been chosen (Step 1315), the weight on green (G) is reduced (Step 1316) in order to prevent erroneous focusing on green leaves rather than th4e flower that is the targeted subject.

In cases other than any of the ones previously discussed, to be more specific, in cases where none of the modes for tracking color temperature or white balance has been selected (Step 1308), and no specific photographing mode is set, in other words, in the case of what is referred to as a no-setting mode (Step 1310), a preset weight is set (Step 1317), and the variable CN, which represents the number of color data items, is stored as 3 (CN=3) (Step 1306). With the non-specific mode, a weight may be set so as to facilitate focusing on, for example, human skin color.

As described above, preset amounts of weights are sets in Steps 1309, 1312, 1314, 1316, 1317, 1408, 1409, 1411, 1413 and 1415 in the image signal determination processing and the auxiliary light determining processing shown in FIGS. 13 and 14. Based on the color data or the brightness data set in the manner described above, color data or brightness data is set in the matrix complementary circuit 27 and the switch 28 shown in FIG. 2.

After the process from Step 101 to Step 120 shown in FIG. 11 is completed, the final focusing calculation in the focusing process is determined based on the selected photographing mode.

The process from Step 11 to Step 106 is repeated to obtain evaluated values of one set of continuous image data. In cases such as when there are a plurality of color data items, a plurality of sets of evaluated values are obtained. If such is the case, in order to process the plurality of sets of evaluated values, the process of calculation of the reliability of each window in Step 111 and the process of multiplication of the weight on each evaluated value in Step 115 are different from those of the constitution shown in FIG. 7.

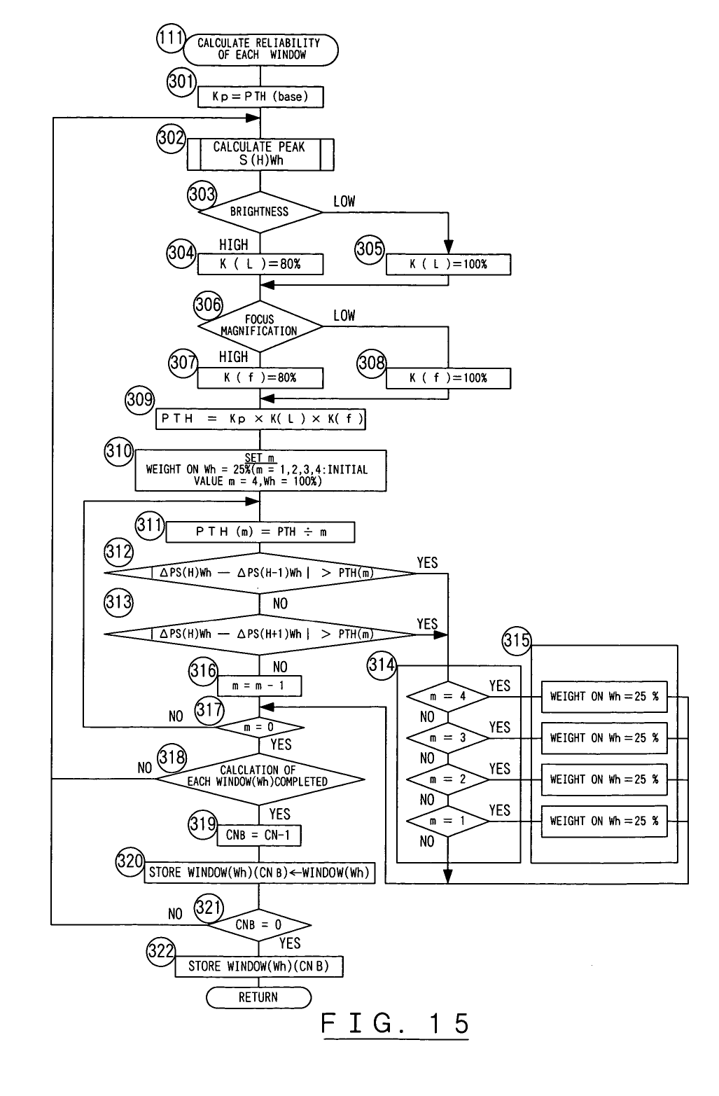

To be more specific, the weight on each evaluated value obtained from image data containing brightness data or color data selected as above can be set in step 111 shown in FIG. 11, i.e. the process shown in FIG. 15. However, should there be a plurality of color data items of the image data, the evaluated value for each window Window(Wh) is calculated by using the color data CN, which has been stored beforehand. First, in the same manner as the process shown in FIG. 9, a series of processes from Step 301 to Step 318 shown in FIG. 15 are conducted in the same manner as the processes shown in FIG. 9. The value CNB is then calculated from the equation CNB=CN−1 (Step 319). Thereafter, the evaluated value Window(Wh) that has been calculated as above is replaced with the amount of the weight Window(Wh) (CNB) (Step 320). Should the calculated result of the value CNB be 0 (Step 321), it is obvious that either brightness data alone or color data of a single color is sufficient. Therefore, the value of the amount of the weight Window(Wh) (CNB), which has replaced the evaluated value Window(Wh) in Step 320, is stored as a calculated result of reliability (Step 322). In the case of CN=3, calculation of an amount of weight Window(Wh) (CNB) is repeated until processing of the color data for all three colors is completed. After calculation of all the sets of evaluation values, in other words, calculation for all the colors, is completed, the amounts of the weights Window(Wh) (CNB) for the color data of the evaluated values Window(Wh) for the respective windows are stored (Step 322).

After the process from Step 112 to Step 114 in the flow chart shown in FIG. 11 is completed, calculation is performed by multiplying the evaluated values by the weights by using the amounts of the weights Window(Wh) (CNB) for the color data of the evaluated values Window(Wh) for the respective windows (Step 115). This calculation is a process of multiplying each evaluated value by reliability, i.e. an amount of weight. In the case of the present embodiment, calculation is performed for each color data, because the color data evaluated value and its reliability have already been obtained for each window. Therefore, weighting calculation for an evaluated value Window(Wh) of each window is performed based on the equation:
Evaluated value(Wh)=Σ{FocusValue(CNB)×Window(CNB)}/CNB

However, in the case of CN=1, the calculation is performed in the same manner as Step 115 shown in FIG. 7.

The entire evaluated values of each window W1-W9 are multiplied by the evaluated value (Wh) that has been found as above.

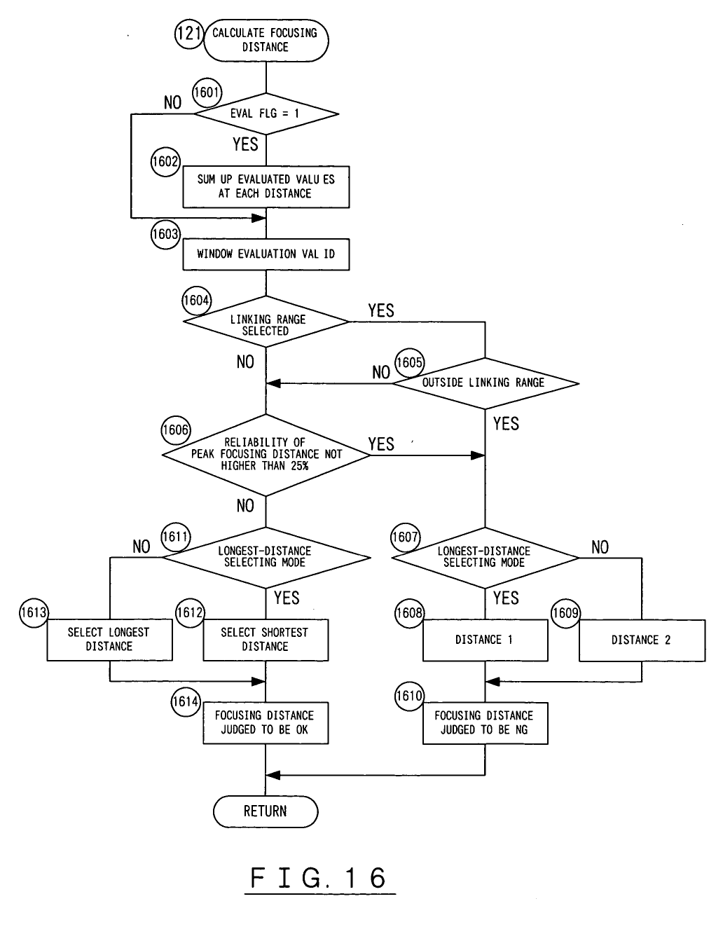

After the process from Step 117 to Step 120 shown in FIG. 11 is completed, focusing distance calculation shown in FIG. 16 is performed in step 121, instead of the steps shown in FIG. 10.

First, in the same manner as the process shown in detail in FIG. 10, whether calculation using a weighting factor has been performed is determined from the state of Eval FLG (Step 1601). In cases where weighting has been performed, the weighted evaluated values are summed up at each distance (Step 1602). In cases the evaluated values have not been weighted, summation is not performed. Peak focusing positions, i.e. peak positions, are calculated from the evaluated values (Step 1603). In cases where the photographing range, i.e. the linking range, has been set based on the photographing mode selected in Step 11 shown in FIG. 11 (Step 1604), should all the peak focusing positions be outside the preset photographing range (Step 1605), or every peak focusing position have a reliability not higher than a given level, e.g. 25% (Step 1606), it is judged that calculation of the subject distance is impossible (Step 1607). In this case, the focusing position, i.e. the focal point at which the lens will be focused, is compelled to be set at a given value, based on the photographing mode set in Step 11. The photographing mode is either the shortest-distance selecting mode or the longest-distance selecting mode. Therefore, in cases where calculation of the subject distance is judged to be impossible, it is determined whether the current mode is the longest-distance selecting mode (Step 1607). When the current mode is the longest-distance selecting mode, a given distance, i.e. Distance 1, is set (Step 1608). When the current mode is not the longest-distance selecting mode, another given distance, i.e. Distance 2, is set (Step 1609). Distance 1 is greater than Distance 2 (Distance 1>Distance 2). At that time, focusing distance determination is judged to be NG (Step 1610).

Should every peak focusing position have a reliability not higher than a given level, e.g. 25% (Step 1606) in the situation where the linking range has not been set based on the photographing mode determined in Step 11 shown in FIG. 11 (Step 1604), calculation of the subject distance is judged to be impossible (Step 1607), and the same procedure as above is followed (Steps 1608-1610).

In cases other than the previously discussed Steps 1604-1605, to be more specific, in cases where the linking range has been set (Step 1604), one or more peak focusing positions (peak positions) are in the range of photographing distance that corresponds to the set photographing mode (Step 1605), and such peak focusing position(s) in the photographing range have a reliability greater than a given level, e.g. 25% (Step 1606), calculation of the subject distance is judged to be possible. In order to decide the peak position, which photographing mode has been selected in Step 11 is determined. Should the longest-distance selecting mode be the selected mode (Step 1611), the partial focusing position having the peak position at the longest distance is selected from among the valid windows W1-W9 and set as the focusing position (Step 1612). Should the longest-distance selecting mode be not the selected mode (Step 1611), in other words in cases where the current mode is the shortest-distance selecting mode, the partial focusing position having the peak position at the shortest distance is selected from among the valid windows W1-W9 and set as the focusing position (Step 1613). At that time, focusing distance determination is judged to be OK (Step 1614).

Should there be at least one peak focusing position having a reliability higher than a given level, e.g. 25% (Step 1606) in the situation where the linking range has not been set based on the photographing mode determined in Step 11 shown in FIG. 11 (Step 1604), calculation of the subject distance is judged to be possible, and the same procedure as above is followed (Steps 1611-1614).

According to the result of focusing distance determination (Step 1610 or 1614) which has been obtained by focusing distance calculation described above (Step 121), as shown in FIG. 7, judgment is made as to whether the result of focusing distance determination is OK or NG (Step 122). If the result is OK, the lens of the optical system 11 is moved to the calculated focusing position (Step 123). In case of NG, the lens of the optical system 11 is moved to the aforementioned preset focusing position, i.e. Distance 1 or Distance 2 (Step 124). Thus, the lens can be positioned at the final focusing position.

As is described above, according to the present embodiment, use of color data when detecting a focal length based on image data enables the correct detection of the focal length for a subject containing various color data in various photographing conditions. In other words, the embodiment increases the accuracy of focusing by providing a range finding method which calls for applying weight calculation to contrast evaluated values of the color signals of the image signals and thereby using only the optimal data and a focusing device using such a range finding method. Unlike a constitution that involves focusing based on evaluated values obtained by extracting only high-frequency components of brightness signals obtained from image data, using information other than brightness data, such as color data, enables the range finding for a subject, the distance to which cannot be measured from evaluated values of high-frequency components that have been extracted based only on difference in brightness. Therefore, the present embodiment enables the reduction of the types of subjects that present difficulties in focus control.

To be more specific, a focusing device according to the present embodiment has a means to detect contrast evaluated values for a plurality of color data, in other words contrast evaluated values for respective multiple image data obtained through at least two color filters of different colors, and a means (the matrix complementary circuit 27 and the switch 28) and processes (See Step 12 in FIG. 11) to make selection from among said multiple image data and perform calculation on the selected image data, in addition to conducting a focusing process for each one of the multiple image data. The device according to the embodiment also has a means to perform weighting calculation for contrast evaluated values of each image data selected and processed by said means and processes.

According to the present embodiment, the amount of the weight of reliability of each evaluated data that has been obtained for each one of multiple image data is calculated for each one of the plurality of image detecting areas defined in each image data (See Steps 319-322 in FIG. 15).

Furthermore, calculation (See Step 115 in FIG. 11) is performed to apply weighting (See Step 111 in FIG. 11) to the evaluated values obtained based on the photographing mode (See Steps 11-12 in FIG. 11, FIG. 12 and FIG. 13). Then, based on the evaluated values to which weighting has been applied, a given focal length appropriate for the photographing mode is selected from among partial focal lengths of the image detecting areas.

Based on output color data or white balance signals, the image processing circuit 15 consisting of the CPU 17 and other components performs application (See Step 115 in FIG. 11) of weighting (See Step 111 in FIG. 11, Step 1309 in FIG. 13 and other relevant steps) to the obtained evaluated values and, by using the evaluated values to which weighting has been applied, selects a given focal length appropriate for the photographing mode from among partial focal lengths of the image detecting areas.

A focusing device according to the present embodiment has a means to automatically (See the procedure from N0 in Step 1301 onwards in FIG. 13) change over multiple image data (See the matrix complementary circuit 27, the switch 28 and Step 12 in FIG. 11) used for calculation of the focal length.

A focusing device according to the present embodiment has a means to manually (See the procedure from YES in Step 1301 onwards in FIG. 13) change over multiple image data (See the matrix complementary circuit 27, the switch 28 and Step 12 in FIG. 11) used for calculation of the focal length.

A focusing device according to the present embodiment has a means to automatically change over the image data containing the color data (See the matrix complementary circuit 27) used for calculation of the focal length based on the brightness of the subject (See Step 1307 in FIG. 13).

A focusing device according to the present embodiment has a means (See Steps 1301-1305 in FIG. 13) to enable the photographer to set a desired amount of weight (See Step 12 in FIG. 11) for each contrast evaluated value obtained from the image data (See the matrix complementary circuit 27, the switch 28 and Step 12 in FIG. 11) used for calculation of the focal length.

Furthermore, according to the present embodiment, evaluation is performed based on weighting, and a given focal length appropriate for the photographing mode is selected from among partial focal lengths of the image detecting areas.

As described above, because of inclusion of a means to select and process a single image signal or a plurality of different image signals from among a plurality of different image data, a means to perform focusing by using evaluated values of a focusing device according to the present embodiment is able to recognize the contrast of an image in wide range of situations, in other words, recognize the contrast of a subject image containing various color data under various photographing conditions. Furthermore, by applying weighting to evaluated values of each image data of a plurality of photographed images, the device according to the embodiment is capable of focusing calculation appropriate for the features of the subject.

As weighting is applied to evaluated values of each one of multiple image data based on color data or white balance, contrast is evaluated in accordance with the optimum criteria for the subject.

The embodiment also includes an automatic mode for automatically selecting multiple image data based on a subject. Therefore, by using the automatic mode, the photographer can concentrate on taking pictures.

The embodiment also includes a manual mode for making selection of multiple image data manually. Therefore, by using the manual mode, the focusing process can directly reflect the photographer's intentions. As manual setting enables not only selection of image data but also direct setting of the amounts of the weights, which are essential for weight calculation in the focusing process, the manual setting enables focusing even under certain photographing conditions that would make focusing by a conventional constitution difficult.

As the manual mode includes a mode for permitting the photographer to select image data for focusing or set the amounts of the weights based on the selected photographing mode or other selection of conditions under which a subject is photographed, a focusing position that meets the photographer's expectation can be selected.

Conventional focusing processing that calls for calculation of a plurality of focal lengths in a plurality of areas and determination of the final focal length is performed by using brightness data alone or a single type of information that is similar to brightness data. However, by using evaluated values based on color data of different colors and applying weighting to these evaluated values with the photographer's intention reflected in the weighting by setting a photographing mode or by any other means, the present embodiment enables accurate focusing. Furthermore, in the automatic mode, the constitution according to the present embodiment enables easy and accurate focusing by discerning features of the subject based on the color data and automatically weighting the evaluated values.

There may be occasions where a constitution that uses only a data of brightness or a single color is unable to detect contrast in an image having a uniform brightness even if the contrast is recognizable to the human eye because of color data. However, even under poor photographing conditions, such as when movement of the subject or camera shake is occurring in low-light condition, the use of data of a plurality of types selected from data of different colors and brightness enables the detection of contrast edges and also prevents erroneous recognition of a peak of evaluated values. Therefore, accurate focusing even on such a subject as one for which focusing is difficult by a conventional method or device is ensured.

When the photographer uses the manual mode in order to achieve focusing based only on color data of a specific color of a subject, the photographer can set the weights to be placed on the evaluated values based on spectral color data or brightness data of image data to be used for focusing. This feature of the embodiment enables focus control that meets the photographer's expectation by permitting the photographer to select color data according to the specific color of the subject and set a desired weighting for each color data. For example, the color of a human face is not prone to be affected by other colors, although it has a relatively low contrast. In such a case, according to the present embodiment, it is possible to select color data or brightness data with the skin color being defined as a specific color and place a great weight only on the skin color when processing the evaluated values.

When taking a picture that includes flowers, should a photographer wishing to focus on the petals of a flower use only brightness data in the evaluation process, this may cause green leaves surrounding the flower petals to be erroneously detected as a peak of evaluated values, resulting in a failure to focus on the flower petals. The present embodiment is free from such a problem; in cases the flower petal are, for example, blue, using only blue color data for the evaluation process enables the focusing device to reliably recognize the flower petals as the targeted subject, ensuring reliable focusing on the blue petals even if it is outdoor shooting which is susceptible to subject shaking due to wind or other causes. As a photographing mode for calculating a focal length by using only image data that consists of color data of a specific color based on a subject is thus provided, using only the image data that consists of the color data of a specific color ensures easy focusing on a subject on which the operator intends to focus on without being affected by other color data.

The present embodiment is provided with a brightness detecting circuit, auxiliary light sources L1,L2, and light source circuits 43,44 for respectively controlling the auxiliary light sources L1,L2. The brightness detecting circuit consists of the CPU 17 and other components and serves to measure brightness. The auxiliary light sources L1,L2 are a plurality of light sources adapted to support, based on brightness, photographing of images to obtain data for focal length detection. With the structure as above, control of light emission from the auxiliary light sources L1, L2 (See Steps 1406, 1407, 1410, 1412 and 1414 in FIG. 14) and weighting calculation (See Steps 1408, 1409, 1411, 1413 and 1415 in FIG. 14) are performed based on brightness data or color data (See Steps 1403 and 1404 in FIG. 14).

Furthermore, the embodiment includes what may be called a selective control enabling circuit (See the light source circuits 43,44 and the switches 45,46 in FIG. 2) for selecting any one or a plurality of light sources from among the auxiliary light sources L1,L2 and causing the selected auxiliary light source(s) L1,L2 to emit light simultaneously.

An auxiliary light determining means to make selection of auxiliary light sources L1,L2 is provided with a selecting means to control the auxiliary light sources L1,L2 either automatically or manually.

When selecting auxiliary light sources L1,L2 manually (See Step 1402 in FIG. 14), it is possible to perform weighting calculation (See Steps 1408, 1409, 1411, 1413 and 1415 in FIG. 14) based on color data of the light beams from the plurality of light sources L1,L2 (See Steps 1406, 1407, 1410, 1412 and 1414 in FIG. 14).

As described above, a plurality of auxiliary light sources L1,L2 are provided to support focusing. Therefore, even when photographing is performed in low-light conditions, the optimum focusing is ensured by using the auxiliary light sources L1,L2 so as to select the optimum image data from among multiple image data based on color temperatures and other characteristics of light from the auxiliary light sources L1, L2 and use the selected data for weighting calculation.

In other words, as the embodiment described above includes at least one auxiliary light source L1,L2, which is a light source to be used for focusing, and uses the auxiliary light source(s) L1,L2 for weighting evaluated values by causing the auxiliary light source(s) L1,L2 having the optimum color data of these auxiliary light sources L1,L2 to emit light and selecting color data based on color temperatures or other features of the auxiliary light sources L1,L2. Therefore, the embodiment enables accurate focusing while effectively using the auxiliary light source(s) L1,L2. For example, when a red (R) light emitting diode (LED) is used as an auxiliary light source L1,L2, obtaining evaluated values from red color image data and giving a greater weight to red color data so that the auxiliary light reaches a farther distance at a lower cost than in a case where another color is used. As a result, accurate focusing is ensured even on a subject situated in a dark environment.

In cases where a plurality of auxiliary light sources L1,L2 are provided, the possibility of accurate focusing can be increased by selecting the auxiliary light source(s) L1,L2 to emit light based on features of the subject. For example, if three auxiliary light sources L1,L2,L3 (not shown) are provided and these auxiliary light sources L1,L2,L3 emit light beams of red, blue and green colors respectively, it is effective to select based on the color data of the subject the auxiliary light source L1,L2,L3 for emitting light of the color that is deemed to produce the most effective evaluated value and cause the selected auxiliary light source L1,L2,L3 to emit light.

With the configuration as above, wherein one or more auxiliary light sources L1,L2 to emit light can be selected manually or automatically, the photographer can choose the optimum auxiliary light source L1,L2 based on conditions of the subject manually if he has knowledge of auxiliary light sources or automatically if he lacks such knowledge. In either way, the light source the most appropriate for the subject can be easily used for focusing.

Although the present embodiment described above uses RGB-type image data or YCC brightness data as information for obtaining evaluated values from image signals, it is also possible to generate image data of a specific color or color data in the form of CMY color difference consisting of cyan (C), magenta (M) and yellow (Y) by means of the matrix complementary circuit 27 shown in FIG. 2 and use the generated image data for processing. By using appropriate weight variables set based on information of these colors, an accurate focal length can be detected.

Furthermore, the present embodiment enables focusing to the long range side according to the intention of the photographer and thereby facilitates image capturing focused to the long range side as intended by the photographer. To be more specific, based on the range of photographing distance, the photographer can choose either the so-called normal mode or the mode aimed at far distance photography, e.g. the far distance mode or the infinity mode, or, based on a constitution which enables the lens to be focused at any distance within the entire range of photographing distance for which the lens is designed, choose the mode that gives priority to either a short distance or a far distance. As a result of this feature, the photographer can take desired pictures easily. As a focusing position is determined using data which has been obtained from a plurality of image areas and ascertained to be free from any undesirable influence of sudden movement of the subject or the like, in other words data which has been judged to be valid for focusing, pictures can be taken that exactly meet the photographer's expectations. With the features as above, the present embodiment provides a method of automatic focusing which calls for dividing a frame into a plurality of areas and determining a focusing position in each area. Even with a scene containing an obstruction to range finding, such as movement of the subject or camera shake, the method according to the embodiment is capable of appropriate range finding and focusing of the optical system 11 by detecting blur and using only the optimal data, and, therefore is capable of increasing the accuracy of focusing.

Giving priority to the short range when calculating a plurality of focal lengths in a plurality of areas and determining a final focal length is a method generally deemed effective. However, should there be an erroneous peak at a distance shorter than the subject distance due to movement of the subject or camera shake, giving priority to the short range through a conventional process may prevent the subject from being recognized as the focusing position and, instead, cause the erroneous peak to be determined as the focusing position, resulting in failure in setting the correct focusing position. When taking a picture of a subject located at a far distance rather than at a short distance, it is possible in this case too that movement of the subject or camera shake may cause an erroneous peak to be mistaken for the focusing position; the focusing position may be erroneously set at a peak located closer than the real peak or at a peak located even farther than the far distance intended by the photographer (for example, a position farther than the subject that is located farthest in the captured image). In either case, focusing is not done as the photographer intended. However, even if movement of the subject or camera shake generates an erroneous peak at a location closer or farther than the subject distance, the embodiment enables the reliable setting of an appropriate focusing position by detecting the movement of the subject or camera shake and using only the correct evaluated values while giving priority to the short range or long range based on the selected photographing mode.

In cases where the range of photographing distance is set at the normal mode, the shortest-distance selecting mode is automatically selected. In cases where the range of photographing distance is set at the far distance mode, the longest-distance selecting mode is automatically selected. As the subject at the longest distance is selected for the final focusing position from among a plurality of image areas without the shortest distance in the range of photographing distance set by the long-distance mode being erroneously selected as the final focusing position, pictures can be taken as desired by the photographer.

In cases where the configuration of the device permits mode selection between the long-range priority mode and the short-range priority mode from within the entire range of photographing distance, it is sufficient for the photographer to simply choose the long-range priority mode; there is no need of complicated operation by the photographer to visually determine the photographing range (for example, whether the subject is in the macro range or the normal range) beforehand. Together with accurate focusing that calls for determining the final focal length after evaluating the reliability of the data, the embodiment enables accurately focused photography that meets the photographer's intention.

Furthermore, the use of the long-range priority mode also enables accurate focusing to a far distance other than the infinity.

As the method described above calls for calculating and evaluating the distance to the subject in each one of plural areas, it prevents failure in focusing even if the subject has moved or background blur has occurred. Furthermore, even under severe conditions that impair accurate evaluation of the focusing positions, such as when range finding is impossible because contrast evaluated values are too low in all the image areas to produce valid focusing positions, pictures can be taken as desired by the photographer by designating a given distance as the focusing distance based on the photographing mode.

As the present embodiment calls for meeting the photographer's intention, which has been made clear by the selection between short-range priority and long-range priority, the embodiment enables the intuitive confirmation of the focal length prior to an actual photographing action without using complicated algorithms and eliminates the necessity of a special device, such as an optical finder of a single-lens reflex camera or a device that uses a calculation component and serves for enlarged display on an LCD panel. Therefore, compared with a conventional device including a mechanism that permits the camera to automatically recognize the focal length in an image by using a learning function as well as the selection between short-range priority and long-range priority in order to determine the focal length, the embodiment offers a device having a simplified structure at reduced production costs.

The driving range of the lens varies with respect to the range of photographing distance for which the lens is designed, depending on fluctuation resulting from the lens magnification, a change resulting from a change in aperture, as well as temperature, position and other conditions of the lens barrel, which supports the lens. Therefore, taking into consideration the degree of change resulting from changes in these various conditions in addition to the driving range calculated from the range within which the lens is designed to be focused, the optical system 11 is provided with overstroke ranges at the short-range end and the long-range end respectively. An overstroke range is a range in which the lens is permitted to move by the distance corresponding to the degree of change. Furthermore, the control means, which is comprised of the CPU 17 or the like, is adapted to be capable of driving the lens position of the focus lens unit into an overstroke area.

With the structure as above, in the longest-distance selected mode, even if the in-focus position is near the long-range end of the lens driving range and the lens barrel is oriented towards the far distance side, the range of photographing distance is ensured by driving the lens of the focus lens unit into the overstroke area at the long-distance end.

Furthermore, in the shortest-distance selected mode, even if the in-focus position is near the short-range end of the lens driving range and the lens barrel is oriented towards the shortest distance side, the range of photographing distance is ensured by driving the lens of the focus lens unit into the overstroke area at the short-distance end.

As described above, the embodiment enables the photography with possible deviation of the focal point occurring near the short-range end or long-range end taken into consideration, thereby easily ensuring the range of photographing distance without the need for a means of control, mechanical or software, for high precision distance correction. Therefore, the embodiment enables reduced production costs.

According to the present embodiment, the photographer may freely set the range of photographing distance and select the long-range priority mode. However, the structure and operation of the device may be simplified by a constitution that permits only one of the two types of selection, i.e. selection of the range of photographing distance or selection of the long-range priority mode.

As described above, according to a method of detecting a focal length of the present embodiment, the focal length is selected from among the partial focal lengths in the image detecting areas, either the partial focal length at the shortest distance or the partial focal length at the longest distance, in accordance with the operator's choice. The method having this feature enables the selection of an accurate focal length between the shortest focal length and the longest focal length, in accordance with the intention of the operator.

According to a method of detecting a focal length of the present embodiment, a control means selects as the focal length either the partial focal length at the shortest distance or the partial focal length at the longest distance from among the partial focal lengths in the image detecting areas in accordance with the operator's selection of the range of photographing distance. As the control means selects as the focal length either the partial focal length at the shortest distance or the partial focal length at the longest distance from among the partial focal lengths in the image detecting areas in accordance with the operator's selection of the range of photographing distance, the method having this feature enables the selection of an accurate focal length in accordance with the intention of the operator.

According to a method of detecting a focal length of the present embodiment, the focal length is selected based on the reliability between a partial focal length selected from among the partial focal lengths in the image detecting areas and a given focal length. The method having this feature is based on a method of selecting a focal length from partial focal lengths having a high reliability, and enables the selection of an accurate focal length. Should there be no partial focal length having a high reliability or all the partial focal lengths have a low reliability, a preset focal length is used so as to prevent selection of an inaccurate focal length.

According to a method of detecting a focal length of the present embodiment, the focal length is selected, based on the reliability, between a partial focal length selected from among the partial focal lengths in the image detecting areas and a given focal length that has been set as a result of the operator's choice. The method having this feature is based on a method of selecting a focal length from partial focal lengths having a high reliability, and enables the selection of an accurate focal length between the short distance and the far distance in accordance with the intention of the operator. Should there be no partial focal length having a high reliability or all the partial focal lengths have a low reliability, a preset focal length that corresponds to the operator's choice is used so as to prevent selection of an inaccurate focal length, while reflecting the intention of the operator.

A focusing device according to the present embodiment is provided with a photographing mode selecting means adapted to make selection between a short-distance priority mode and a long-distance priority mode, and the image processing means of the focusing device is adapted to select the focal length with priority given to either the partial focal length at the shortest distance or the partial focal length at the longest distance in accordance with the result of operation of the photographing mode selecting means. The device having this feature enables the selection of an accurate focal length between the short distance and the far distance, in accordance with the intention of the operator. As the device is capable of performing this function without complicating its structure, production costs can be kept under control.

A focusing device according to the present embodiment has an optical system driving means that is capable of driving the optical system into an overstroke range, which is a range beyond the range of focal length for which the optical system is designed. The device having this feature enables easy and accurate focusing at a short distance or a far distance regardless of deviation of the focal point of the optical system resulting from temperature, orientation of the optical system or other conditions.

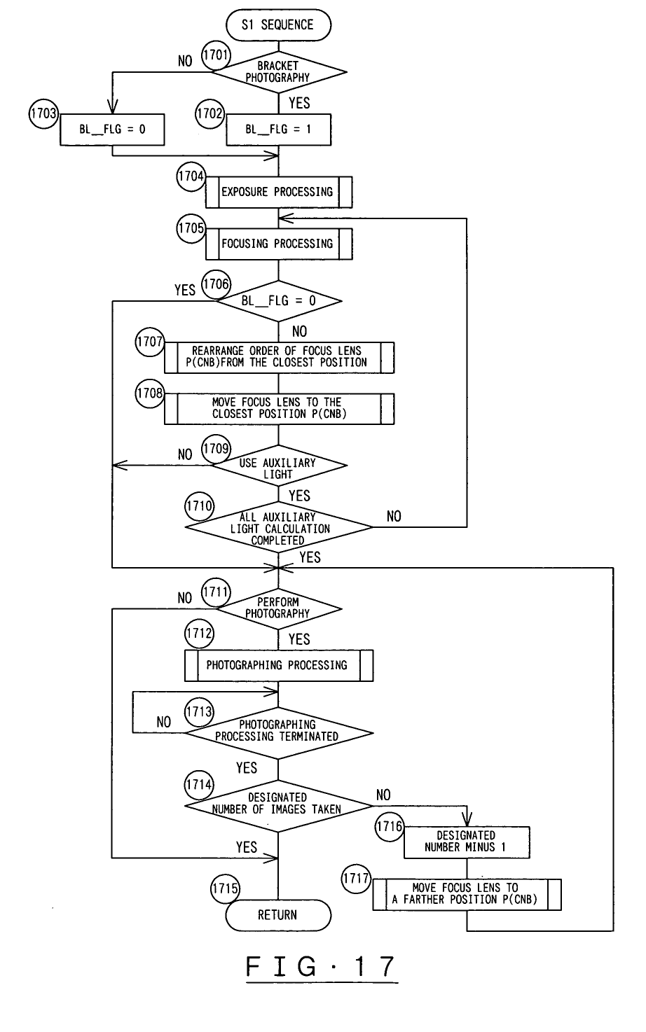

An image capturing apparatus according to another embodiment of the invention is explained hereunder, referring to FIGS. 17 through 19.

While being based on the constitution described above, the present embodiment involves focus bracket photography, which calls for the photographer to use color data of a plurality of colors generated from image data for calculation of different partial focal lengths for respective color data and take pictures at the respective calculated partial focal lengths. As a prerequisite, bracket photography according to the present embodiment includes the following steps or processes in selection of the photographing modes (Step 11) shown in FIG. 12: calculation of partial focal lengths by using color data within the scope that corresponds to the range of photographing distance selected in Step 1201, selection of the photographing modes (Step 1310) included in image signal determining processing shown in FIG. 13, and various control processes, such as control of whether or which of the auxiliary light sources L1,L2 to be caused to emit light and employing a combination of a plurality of photographing modes.

First, S1 sequence, which is a sequence for photographing a still image, is explained, referring to a flow chart shown in FIG. 17. In the S1 sequence, the shutter button is in a half-depressed state. First, judgment is made as to whether the photographer has already made selection of bracket photography (Step 1701). In cases where bracket photography has been selected, the variable BL_FLG is set at 1 (BL_FLG=1) (Step 1702). In cases where bracket photography has not been selected, the variable BL FLG is set at 0 (BL_FLG=0) (Step 1703). The variable BL_FLG is used for determining in a later step whether or not bracket photography is going to be performed. Then, exposure processing is performed (Step 1704). The objective of the exposure processing is to determine control criteria to achieve appropriate exposure with regard to a subject. The exposure processing primarily consists of setting the shutter speed, the aperture and the gain of the CCD 12 which serves as an image pickup device.

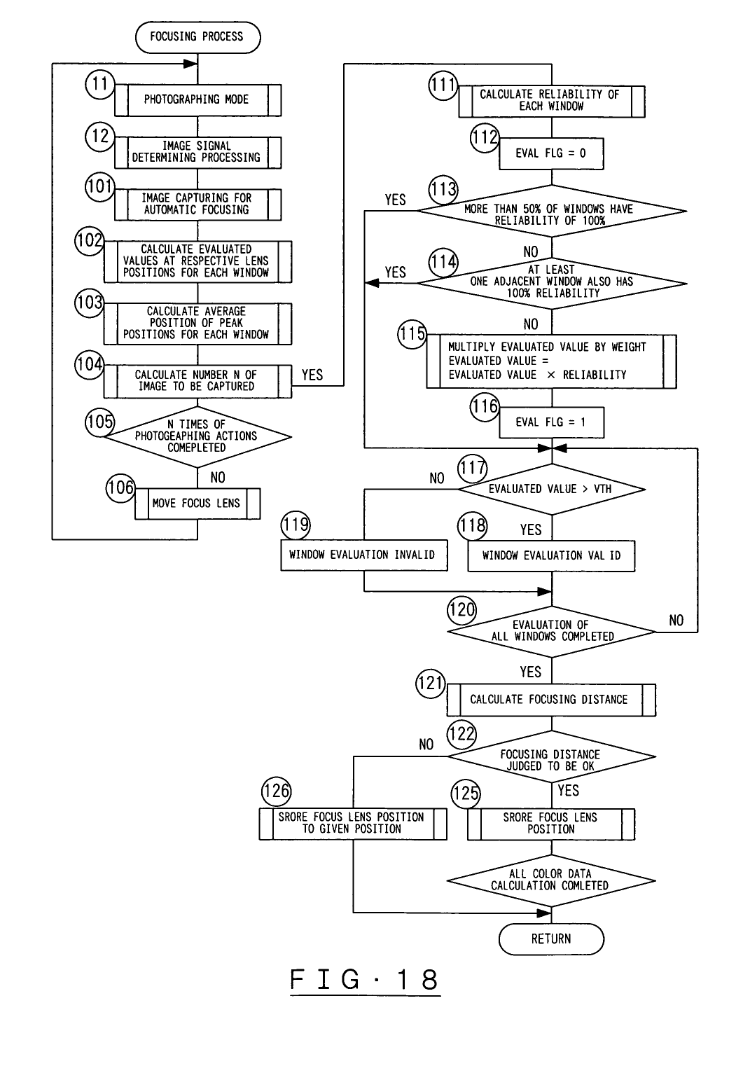

Next, focusing processing is performed (Step 1705). First, details of focusing processing to be performed in cases where use of auxiliary light has not been set is explained in detail, referring to primarily FIG. 18. In FIG. 18, the process from Step 11 to Step 106 is conducted in the same manner as that shown in FIG. 11. In Step 111 for calculating reliability of each window, the amount of the weight Window(Wh) (CNB) to be placed on the reliability of each color data is calculated (Step 322) as shown in FIG. 15. After the process in Steps 112-114 shown in FIG. 18 is completed, weighting calculation for the evaluated value of each color data is performed (Step 115) in the same manner as the process shown in FIG. 7. Then, after the process in Steps 116-120, focusing distance calculation is performed based on the calculated evaluated values (Step 121). If the result of focusing distance determination is OK (Step 122), the current state of the focal length, i.e. the focus lens position P(CNB), is stored (Step 125). If the result of focusing distance determination is NG (Step 122), a given focal length which has been set beforehand, i.e. a preset focus lens position P(CNB), is stored (Step 126). CNB mentioned above represents the number of color data items. For example, in cases where three colors consisting of R (red), B (blue) and G (green) are used, CNB is set as 3 so that three focal lengths are calculated. When calculation of all the focal lengths is completed (Step 127), the processing returns to the flow chart shown in FIG. 17. In other words, when the focusing processing (Step 1705) described above is completed, the focus lens position corresponding to each respective color data has been calculated.

In cases where the variable BL_FLG is 0 (Step 1706) in the flow chart shown in FIG. 17, the procedure shifts to determination as to whether actual photography should be performed (Step 1711). In cases where the variable BL_FLG is 1 (Step 1706), the calculated focus lens positions P(CNB) are rearranged sequentially from the shortest focal length (Step 1707), and the lens of the optical system 11 is moved to the closest focus lens position P(CNB) (Step 1708). In other words, the lens is moved to an end of the linking range as the initial setting in order to perform photographing in succession at a plurality of focus lens positions P(CNB). Therefore, although the calculated focus lens positions P(CNB) are rearranged sequentially from the shortest focal length so that images are photographed in sequence from the shortest focal length, the calculated focus lens positions P(CNB) may be rearranged sequentially from the longest focal length to photograph images in sequence from the farthest distance.

As the next step in the focusing processing in Step 1705, whether or not use of auxiliary light has been selected (See Step 1311 in FIG. 13) is determined by the auxiliary light determining means or the like (Step 1709). In cases where a single auxiliary light source is going to be used (Step 1710), the procedure shifts to whether or not to photograph (Step 1711) In cases where a plurality of auxiliary light sources are going to be used (Step 1710), focusing processing is performed for every combination of the auxiliary light sources to be used so as to calculate each respective focus lens position P(CNB) (Step 1710).

After the lens movement described above, the shutter button is depressed so that, in cases where still-image photography is enabled (Step 1711), photographing processing (Step 1712) is initiated. The system is at a standstill until the photographing processing is completed (Step 1713). After the photographing processing is completed, judgment is made as to whether a specified number of images has been photographed (Step 1714).

In cases where a single auxiliary light source is used, the number of images taken by bracket photography is CNB. Should it be found in Step 1714 that photographing of a specified number of images has not been completed, the specified number on a counter is reduced by one (−1) (Step 1716). Thereafter, the lens is moved to a focus lens position P (CNB) for a location farther than that for the current lens position (Step 1717). Thus, until the specified number (CNB) of frames of photographs are taken, lens moving and photographing actions are repeated (Steps 1711-1717).

It is thus possible to perform bracket photography, which refers to successive photographing actions at different focal lengths, can be performed by using the partial focal lengths for the image detecting areas obtained for each color data.

The S1 sequence described above is primarily for conducting exposure processing (Step 1707) and focusing processing (Step 1708) in a sequence throughout which the shutter button is in the half-depressed state. In the state where the shutter button is fully depressed (Step 1711), photographing processing (Step 1712), i.e. an actual bracket photographing action to take still images, is performed (Step 1712). When the shutter button is not in the fully-depressed state (Step 1711) or the specified number of images have been photographed (Step 1715), the S1 sequence is terminated (Step 1715).

Although it is not shown in the drawings, in cases where the S1 sequence has been terminated and the shutter button is in the half-depressed state, the data on the focus lens positions P(CNB) is maintained until the shutter button is fully depressed again. Therefore, bracket photography can be performed by depressing the shutter button further to the fully-depressed position.

In cases where still-image photography was not enabled in Step 1711, the lens is set at a given position which is appropriate for the photographing mode and selected from among the focal lengths calculated for the respective color data.

When the photographing processing (Step 1712) for bracket photography is initiated, a warning is displayed on the image display unit 21 indicating the initiation of bracket photography. This warning may be displayed until the first photographing processing is completed (Step 1713) or until the entire S sequence is completed (Step 1713). By thus notifying the photographer that bracket photography is taking place, the photographer is prevented from moving the image capturing apparatus 10 away from the subject during a photographing action. Although it is not shown in the drawings, the image capturing apparatus 10 may be provided with an audio means, such as speakers, so as to sound a warning at the same moment as the displayed alert. Such an audio warning may be employed together with or instead of a warning display.

As described above, by performing bracket photography at optimum focusing positions for respective color signals, in other words by means of a focusing device that enables bracket photography at optimum focusing positions for respective color signals, which have been obtained by applying weighting calculation to the contrast evaluated values of the respective color data contained in the signals representing each image, the present embodiment increases the possibility of capturing an image for which the lens is correctly focused for a subject on which the photographer intends to focus.

To be more specific, the present embodiment offers calculation processing which includes a means to detect contrast values of respective image data, i.e. image signals, obtained through at least two different color filters (See the matrix complementary circuit 27) and has a function of performing focusing processing for each one of these image signals in the same manner as in the case of the constitution described above and shown in FIGS. 1 through 16. The calculation processing further includes a means to make selection from among said image signals and apply calculation processing to the selected image signal(s) (See the matrix complementary circuit 27, the switch 28 and the Step 12 in FIG. 18) as well as a means to have the lens focus on a subject by applying weighting calculation to the evaluated values of the respective image data obtained by the aforementioned means to perform selection and calculation. The present embodiment also includes a bracket photographing mode (See FIG. 17, which comprises steps of setting a plurality of image detecting areas in each one of the multiple image data, calculating the amount of the weight of reliability of each evaluated value that has been obtained for each image detecting area (See Steps 319-322 in FIG. 15), selecting a given focal length for each output color data from among partial focal lengths in each respective image detecting area based on the evaluated values (See Step 115 in FIG. 7 and Step 115 in FIG. 18) of the partial focal lengths and the employed photographing mode (See Step 11 in FIG. 18), storing distance information for the color data of each respective color (See Steps 125 and 126 in FIG. 18), and taking a plurality of photographs sequentially at the respective partial focal lengths.

By thus including a means to calculate given focal lengths that are appropriate for the photographing mode from partial focal lengths calculated for the respective image data generated from the data of the initial photographed image (See Step 12 in FIG. 18) and to take photographs sequentially at the calculated focal lengths respectively, the present embodiment enables photography at a focusing position appropriate for features of the subject without having to be concerned with possible deviation of the focal point resulting from a minute difference in colors of the subject.

In other words, in a method or a device for calculating a plurality of focal lengths by using a plurality of image detecting areas and deciding the final focal length from among the calculated focal lengths, partial focal lengths are calculated from multiple image data containing information of different colors. Therefore, by calculating the optimum partial focal lengths for the respective color image data and performing bracket photography based on these partial focal lengths, the present embodiment enables the photographer to obtain an optimum image with a single photographing. According to the present embodiment, whereas the manual mode makes it possible to give evaluated values different weights based on color data of different colors, thereby enabling bracket photography performed exactly as the photographer desires by means of setting of the photographing mode or other criteria, the automatic mode makes it possible to determine characteristics of the color data of the subject by automatically confirming white balance, color data of light emitted from auxiliary light sources, etc., and apply weighting to evaluated values accordingly so as to achieve easy and accurate focusing.

When using a conventional focusing device which uses only one type of data, i.e. brightness data or color data of a single color, there may be occasions where the device is unable to detect contrast even if the contrast is recognizable to the human eye because of color data. Such a failure in recognition of contrast often occurs when the parts of the patterns that constitute the subject to be photographed have the same brightness. In the case of the present embodiment, however, particularly in low-light condition or when movement of the subject or camera shake is occurring, the aforementioned use of multiple image data containing information of different colors enables the photographer to take a series of photographs with a single photographing action at the optimum partial focal lengths for the respective color data. Therefore, even if the photographer does not have sufficient knowledge of color data, it is possible to photograph an accurately focused subject for which focusing had been difficult for a conventional AF device.

When taking a picture that includes, for example, a flower, should the photographer wishing to focus on the petals of a flower use only brightness data in the evaluation process, this may cause green leaves surrounding the flower to be erroneously detected as a peak of evaluated values, resulting in a failure to focus on the flower petals. The present embodiment is free from such a problem because partial focal lengths can be calculated from more appropriate data, such as color data; for example, photographing can be performed by focusing on flower petals of a specific color by detecting the partial focal length for the color data corresponding to the color of the flower petals. Furthermore, should there be flowers of different colors, images that include an optimally focused image can be captured by taking a series of photographs focused on the flower petals of the respective flowers with a single photographing action.

Furthermore, it is possible to prevent the photographer from moving the image capturing apparatus 10 in the course of bracket photography by providing the image capturing apparatus with a warning means for notifying the photographer that bracket photography is taking place during or at the beginning of bracket photography. The warning means may use the image display unit 21 to visually display that bracket photography is underway or, either instead of or together with the visual display, use an audio means (not shown) to indicate bracket photography operation by voice or other sound.

Although the explanation of the embodiment shown in FIG. 17 pertains only to whether or not auxiliary light is used as a photographing, the invention is not limited to such a constitution; it is also possible to provide a bracket photography mode which permits selection of a plurality of photographing modes (See Step 11 in FIG. 12) and take a series of photographs in each photographing mode at a plurality of partial focal lengths based on contrast evaluated values of multiple image data respectively obtained from information of different colors.

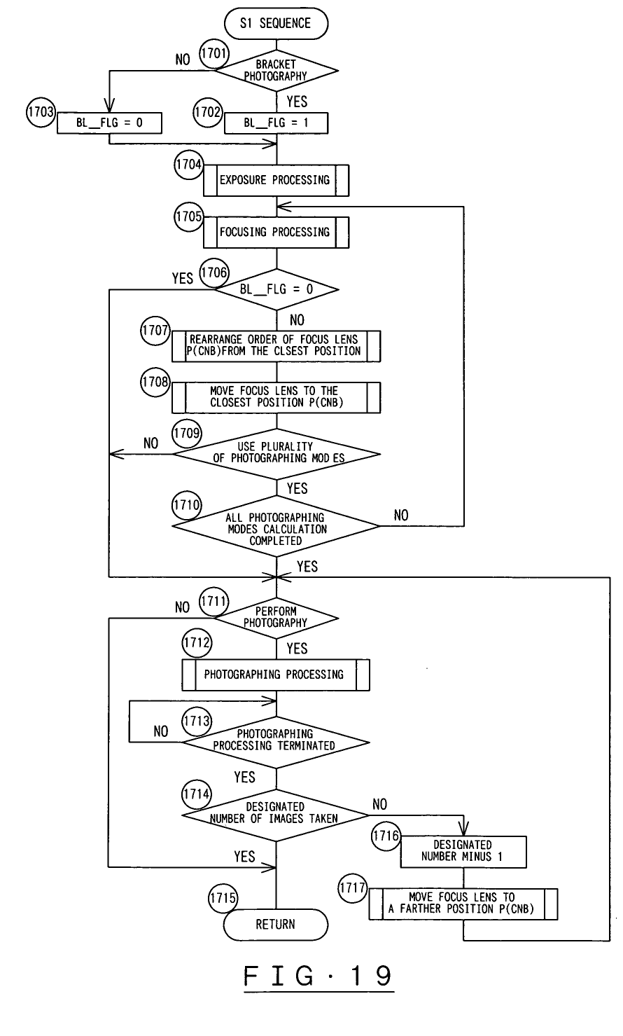

For example, instead of auxiliary light processing shown in Steps 1709,1710 in FIG. 17, procedures in Steps 1709,1710 shown in FIG. 19 may be followed. To be more specific, after the calculated focus lens positions P(CNB) are rearranged sequentially from the shortest focal length (Step 1707) and the lens of the optical system 11 is moved to the closest focus lens position P(CNB) (Step 1708), confirmation is made (Step 1709) as to the photographing mode(s) to be employed (See Step 1310 in FIG. 13) in the focusing processing in Step 1705. In cases where a single photographing mode is going to be used (Step 1710), the procedure shifts to determination of photographing (Step 1711). In cases where a plurality of photographing modes are going to be used (Step 1710), focusing processing is performed for each one of the photographing modes to be used so as to calculate each respective focus lens position P(CNB) (Step 1710).

In the same manner as in the processes shown in FIG. 17, after the lens movement described above, the shutter button is depressed so that, in cases where still-image photography has been enabled (Step 1711), photographing processing (Step 1712) is initiated. The system is at a standstill until the photographing processing is completed (Step 1713). After the photographing processing is completed, judgment is made as to whether a specified number of images have been photographed (Step 1714).

In cases where a single auxiliary light source is used, the number of images taken by the bracket photography is CNB. Should it be found in Step 1714 that photographing of a specified number of images has not been completed, the specified number on a counter is reduced by one (−1) (Step 1716). Thereafter, the lens is moved to a focus lens position P(CNB) for a location farther than that for the current lens position (Step 1717). Thus, until the specified number (CNB) of frames of photographs are taken, lens moving and photographing actions are repeated (Steps 1711-1717).

It is thus possible to perform bracket photography, which refers to successive photographing actions at different focal lengths, can be performed by using the partial focal lengths for the image detecting areas obtained for each color data.

The present invention is applicable to various image capturing apparatuses, including, but not limited to, digital cameras and video cameras.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A method of detecting a focal length, comprising:
obtaining, while changing the focal length of an optical system, multiple image data selected from among image data including brightness data and a plurality of color data; and
calculating a focal length from the obtained multiple image data by using a peak value of contrast evaluated values of said multiple image data.

2. A method of detecting a focal length as claimed in claim 1, further comprising
weighting the evaluated values of each image data of each respective color data that has been selected is automatically performed based on conditions set for said each image data.

3. (canceled)

4. A method of detecting a focal length as claimed in claim 1, further comprising
providing a photographing mode for calculating a focal length by using only image data that consists of color data of a specific color selected based on a subject.

5. A method of detecting a focal length as claimed in claim 1, 2 or 4, further comprising
emitting auxiliary light with given color data when the image data is obtained, and performing weighting of the evaluated values of the color image data based on the color data of the emitted auxiliary light.

6. A method of detecting a focal length as claimed in claim 1, 2 or 4, further comprising
setting a plurality of image detecting areas adjacent to one another in each one of the obtained multiple image data, calculating a partial focal length for each image detecting area based on which image data the peak value of contrast evaluated values has been recorded in, calculating the reliability of each image detecting area based on the position at which said peak value has been recorded moving across the multiple image data, and
selecting a focal length from a group consisting of said partial focal lengths and at least one given focal length, said focal length selected based on the reliability and the evaluated values of each respective image detecting area.

7. A focusing device, comprising:
an image pickup device,
an optical system for forming an image on said image pickup device,
an optical system driver for changing the focal length of said optical system, and
an image processor for processing image data output from said image pickup device and controlling said optical system driver, wherein
the image processor is adapted to:
while changing the focal length of said optical system, obtain multiple image data selected from among image data of brightness data and a plurality of color data, and
calculate a focal length from the obtained multiple image data by using the peak value of contrast evaluated values of said multiple image data.

8. A focusing device as claimed in claim 7, wherein:
the focusing device is provided with an operating means which enables the operator to perform by the operator's discretion weighting of the evaluated values of each image data of each respective color data that has been selected.

9. A focusing device as claimed in claim 7, wherein:
the image processor is adapted to automatically perform weighting of the evaluated values of each image data of each respective color data that has been selected based on conditions set for said each image data.

10. A focusing device as claimed in claim 7, 8 or 9, wherein:
the focusing device is provided with an auxiliary light device for emitting light with given color data.

11. A focusing device as claimed in claim 7, 8 or 9, wherein:
the image processor is adapted to:
set a plurality of image detecting areas adjacent to one another in each one of the obtained multiple image data, calculate a partial focal length for each image detecting area based on which image data the peak value of contrast evaluated values has been recorded in, calculate the reliability of each image detecting area based on the position at which said peak value has been recorded moving across the multiple image data, and
select a focal length from a group consisting of said partial focal lengths and at least one given focal length, said focal length selected based on the reliability and the evaluated values of each respective image detecting area.

12. An image capturing method, comprising:
using color data of a plurality of colors to detect a focal length for each respective color data and capturing an image at each focal length detected for each respective color data.

13. An image capturing method as claimed in claim 12, further comprising:
simultaneously selecting a plurality of photographing modes can be selected, and detecting focal lengths for each one of the selected photographing modes by using color data of a plurality of colors, and capturing images at the respected focal lengths that have been detected.

14. An image capturing method as claimed in claim 12 or 13, wherein:
the detecting of the focal length comprises:
obtaining a plurality of image data of each respective color data while changing the focal length of an optical system,
setting a plurality of image detecting areas adjacent to one another for the image data of each color data,
calculating a partial focal length for each image detecting area based on which image data the peak value of contrast evaluated values has been recorded in,
calculating the reliability of each image detecting area based on the position at which said peak value has been recorded moving across the multiple image data, and
selecting a focal length from a group consisting of said partial focal lengths and at least one given focal length, said focal length selected based on the reliability and the evaluated values of each respective image detecting area.

15. An image capturing apparatus, comprising:
an image pickup device,
an optical system for forming an image on said image pickup device,
an optical system driver for changing the focal length of said optical system, and
an image processor for processing image data output from said image pickup device and controlling said optical system driver, wherein:
the image processor is adapted to:
obtain a plurality of image data of each respective color data while changing the focal length of said optical system, and
calculate a focal length for each respective color data mentioned above by using the peak value of contrast evaluated values calculated from the obtained multiple image data, and
perform image capturing at each focal length calculated for each respective color data.

16. An image capturing apparatus as claimed in claim 15,
further comprising a warning device for indicating that image capturing is underway.
